(19) United States
(12) Patent Application Publication
(10) Pub. No.: US 2023/0253000 A1
(43) Pub. Date: Aug. 10, 2023

(54) SIGNAL PROCESSING DEVICE, SIGNAL PROCESSING METHOD, AND PROGRAM

(71) Applicant: Sony Group Corporation, Tokyo (JP)

(72) Inventors: Akifumi Kono, Tokyo (JP); Toru Chinen, Kanagawa (JP); Hiroyuki Honma, Chiba (JP); Minoru Tsuji, Chiba (CN); Yoshiaki Oikawa, Kanagawa (JP)

(73) Assignee: Sony Group Corporation, Tokyo (JP)

(21) Appl. No.: 18/013,217

(22) PCT Filed: Jun. 25, 2021
(86) PCT No.: PCT/JP2021/024098

§ 371 Date: Dec. 27, 2022

(30) Foreign Application Priority Data
Jul. 9, 2020 (JP) JP2020-118174
Oct. 9, 2020 (JP) JP2020-170985

(51) Int. Cl. G10L 19/035; G10L 19/008

(52) U.S. Cl. CPC G10L 19/035; G10L 19/008

(57) ABSTRACT

The present technology relates to a signal processing device, a signal processing method, and a program which are capable of improving encoding efficiency.

The signal processing device includes a correction unit configured to correct an audio signal of an audio object based on a gain value included in metadata of the audio object, and a quantization unit configured to calculate auditory psychological parameters based on a signal obtained by the correction and to quantize the audio signal. The present technology can be applied to an encoding device.

### TECHNICAL FIELD

The present technology relates to a signal processing device, a signal processing method, and a program, and more particularly to a signal processing device, a signal processing method, and a program which are capable of improving encoding efficiency.

### BACKGROUND ART

In the related art, encoding of the Moving Picture Experts Group (MPEG)-D Unified Speech and Audio Coding (USAC) standard, which is an international standard, or MPEG-H 3D Audio standard using the MPEG-D USAC standard as a core coder, and the like have become known (see, for example, NPL 1 to NPL 3).

### CITATION LIST

### Non Patent Literature

### [NPL 1]

ISO/IEC 23003-3, MPEG-D USAC

### [NPL 2]

ISO/IEC 23008-3, MPEG-H 3D Audio

### [NPL 3]

ISO/IEC 23008-3:2015/AMENDMENT3, MPEG-H 3D Audio Phase 2

### SUMMARY

### Technical Problem

In 3D Audio which is handled in the MPEG-H 3D Audio standard and the like, it is possible to reproduce the direction, distance, spread, and the like of a three-dimensional sound with metadata for each object such as horizontal and vertical angles indicating the position of a sound material (object), a distance, and a gain for the object. For this reason, in 3D Audio, it is possible to reproduce audio with a greater sense of presence compared to stereo reproduction of the related art.

However, in order to transmit data of a large number of objects realized by 3D Audio, there is a need for encoding technology capable of decoding a larger number of audio channels with higher compression efficiency at a high speed. That is, there is a demand for an improvement in encoding efficiency.

The present technology is contrived in view of such circumstances and enables encoding efficiency to be improved.

### Solution to Problem

A signal processing device according to a first aspect of the present technology includes a correction unit configured to correct an audio signal of an audio object based on a gain value included in metadata of the audio object, and a quantization unit configured to calculate auditory psychological parameters based on a signal obtained by the correction and to quantize the audio signal.

A signal processing method or a program according to the first aspect of the present technology includes correcting an audio signal of an audio object based on a gain value included in metadata of the audio object, calculating auditory psychological parameters based on a signal obtained by the correction, and quantizing the audio signal.

In the first aspect of the present technology, an audio signal of an audio object is corrected based on a gain value included in metadata of the audio object, auditory psychological parameters are calculated based on a signal obtained by the correction, and the audio signal is quantized.

A signal processing device according to a second aspect of the present technology includes a modification unit configured to modify a gain value of an audio object and an audio signal based on the gain value included in metadata of the audio object, and a quantization unit configured to quantize the modified audio signal obtained by the modification.

A signal processing method or a program according to the second aspect of the present technology includes modifying a gain value of an audio object and an audio signal based on the gain value included in metadata of the audio object, and quantizing the modified audio signal obtained by the modification.

In the second aspect of the present technology, a gain value of an audio object and an audio signal are modified based on the gain value included in metadata of the audio object, and the modified audio signal obtained by the modification is quantized.

A signal processing device according to a third aspect of the present technology includes a quantization unit configured to calculate auditory psychological parameters based on metadata including at least one of a gain value and positional information of an audio object, an audio signal of the audio object, and an auditory psychological model related to auditory masking between a plurality of the audio objects, and to quantize the audio signal based on the auditory psychological parameters.

A signal processing method or a program according to the third aspect of the present technology includes calculating auditory psychological parameters based on metadata including at least one of a gain value and positional information of an audio object, an audio signal of the audio object, and an auditory psychological model related to auditory masking between a plurality of the audio objects, and quantizing the audio signal based on the auditory psychological parameters.

In the third aspect of the present technology, auditory psychological parameters are calculated based on metadata including at least one of a gain value and positional information of an audio object, an audio signal of the audio object, and an auditory psychological model related to auditory masking between a plurality of the audio objects, and the audio signal is quantized based on the auditory psychological parameters.

A signal processing device according to a fourth aspect of the present technology includes a quantization unit configured to quantize an audio signal of an audio object using at least one of an adjustment parameter and an algorithm determined for the type of sound source indicated by label information indicating the type of sound source of the audio object, based on the audio signal of the audio object and the label information.

A signal processing method or a program according to the fourth aspect of the present technology includes quantizing an audio signal of an audio object using at least one of an adjustment parameter and an algorithm determined for the type of sound source indicated by label information indicating the type of sound source of the audio object, based on the audio signal of the audio object and the label information.

In the fourth aspect of the present technology, an audio signal of an audio object is quantized using at least one of an adjustment parameter and an algorithm determined for the type of sound source indicated by label information indicating the type of sound source of the audio object, based on the audio signal of the audio object and the label information.

### BRIEF DESCRIPTION OF DRAWINGS

FIG. 1 is a diagram illustrating encoding in MPEG-H 3D Audio.

FIG. 2 is a diagram illustrating encoding in MPEG-H 3D Audio.

FIG. 3 is a diagram illustrating an example of a value range.

FIG. 4 is a diagram illustrating a configuration example of an encoding device.

FIG. 5 is a flowchart illustrating encoding processing.

FIG. 6 is a diagram illustrating a configuration example of the encoding device.

FIG. 7 is a flowchart illustrating encoding processing.

FIG. 8 is a diagram illustrating a configuration example of the encoding device.

FIG. 9 is a diagram illustrating modification of gain values.

FIG. 10 is a diagram illustrating modification of an audio signal according to the modification of a gain value.

FIG. 11 is a diagram illustrating modification of an audio signal according to the modification of a gain value.

FIG. 12 is a flowchart illustrating encoding processing.

FIG. 13 is a diagram illustrating auditory characteristics of pink noise.

FIG. 14 is a diagram illustrating correction of a gain value using an auditory characteristic table.

FIG. 15 is a diagram illustrating an example of an auditory characteristic table.

FIG. 16 is a diagram illustrating an example of an auditory characteristic table.

FIG. 17 is a diagram illustrating an example of an auditory characteristic table.

FIG. 18 is a diagram illustrating an example of interpolation of gain correction values.

FIG. 19 is a diagram illustrating a configuration example of an encoding device.

FIG. 20 is a flowchart illustrating encoding processing.

FIG. 21 is a diagram illustrating a configuration example of an encoding device.

FIG. 22 is a flowchart illustrating encoding processing.

FIG. 23 is a diagram illustrating a syntax example of Config of metadata.

FIG. 24 is a diagram illustrating a configuration example of an encoding device.

FIG. 25 is a flowchart illustrating encoding processing.

FIG. 26 is a diagram illustrating a configuration example of an encoding device.

FIG. 27 is a flowchart illustrating encoding processing.

FIG. 28 is a diagram illustrating a configuration example of an encoding device.

FIG. 29 is a flowchart illustrating encoding processing.

FIG. 30 is a diagram illustrating a configuration example of a computer.

### DESCRIPTION OF EMBODIMENTS

Hereinafter, embodiments to which the present technology is applied will be described with reference to the drawings.

### First Embodiment

### Present Technology

The present technology can improve encoding efficiency (compression efficiency) by calculating auditory psychological parameters suitable for an actual auditory sensation and performing bit allocation in consideration of a gain of metadata applied in rendering during viewing.

First, encoding of metadata and an audio signal of an audio object (hereinafter simply referred to as an object) in MPEG-H 3D Audio will be described.

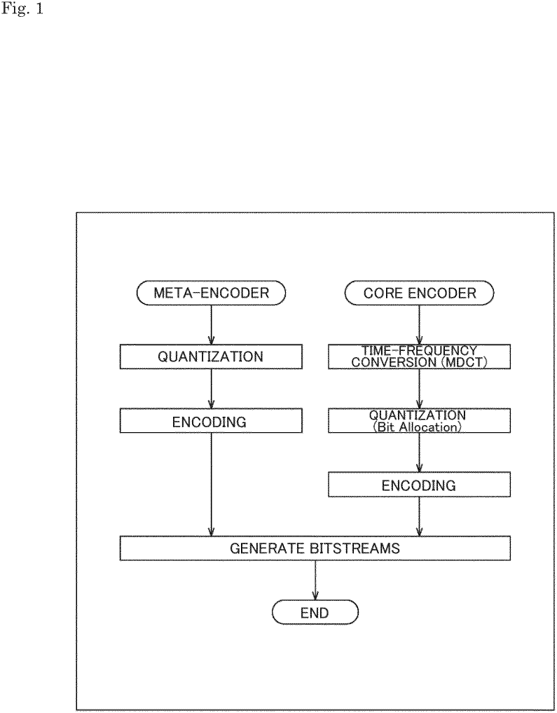

In MPEG-H 3D Audio, metadata of an object is encoded by a meta-encoder, and an audio signal of the object is encoded by a core encoder, as illustrated in FIG. 1.

Specifically, the meta-encoder quantizes parameters constituting metadata and encodes the resulting quantized parameters to obtain encoded metadata.

In addition, the core encoder performs time-frequency conversion using a modified discrete cosine transform (MDCT) on the audio signal and quantizes the resulting MDCT coefficient to obtain the quantized MDCT coefficient. Bit allocation is also performed during the quantization of the MDCT coefficient. Further, the core encoder encodes the quantized MDCT coefficient to obtain encoded audio data.

Then, the encoded metadata and encoded audio data obtained in this manner are put together as a single bitstream and output.

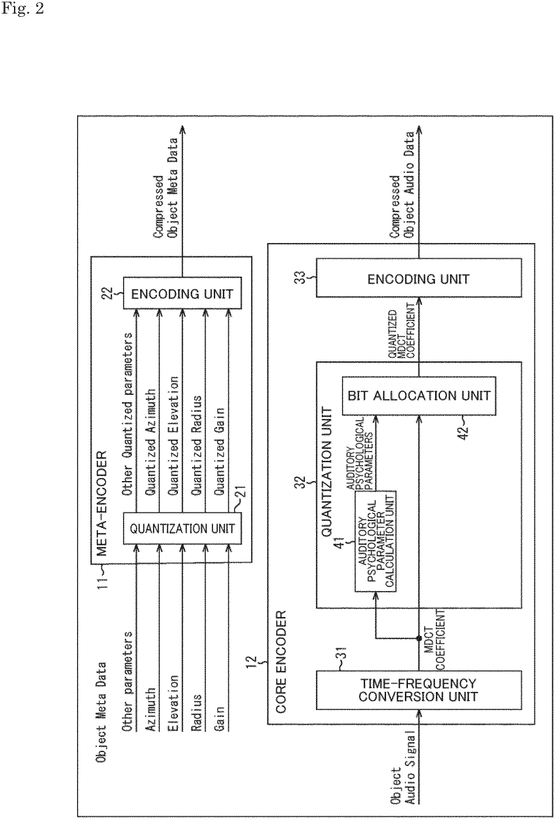

Here, the encoding of metadata and an audio signal in MPEG-H 3D Audio will be described in more detail with reference to FIG. 2.

In this example, a plurality of parameters are input to the meta-encoder 11 as metadata, and an audio signal, which is a time signal (waveform signal) for reproducing a sound of an object, is input to the core encoder 12.

The meta-encoder 11 includes a quantization unit 21 and an encoding unit 22, and metadata is input to the quantization unit 21.

When metadata encoding processing in the meta-encoder 11 is started, the quantization unit 21 first replaces the value of each metadata parameter with an upper limit value or a lower limit value as necessary and then quantizes the parameters to obtain quantized parameters.

In this example, a horizontal angle (Azimuth), a vertical angle (Elevation), a distance (Radius), a gain value (Gain), and other parameters are input to the quantization unit 21 as parameters constituting metadata.

Here, the horizontal angle (Azimuth) and vertical angle (Elevation) are angles in the horizontal direction and the vertical direction indicating the position of the object viewed from a reference hearing position in a three-dimensional space. Further, the distance (Radius) indicates the position of the object in the three-dimensional space, and indicates a distance from the reference hearing position to the object. Information consisting of the horizontal angle, vertical angle, and distance is positional information indicating the position of the object.

Further, the gain value (Gain) is a gain for gain correction of an audio signal of the object, and the other parameters are parameters for spread processing for widening a sound image, the priority of the object, and the like.

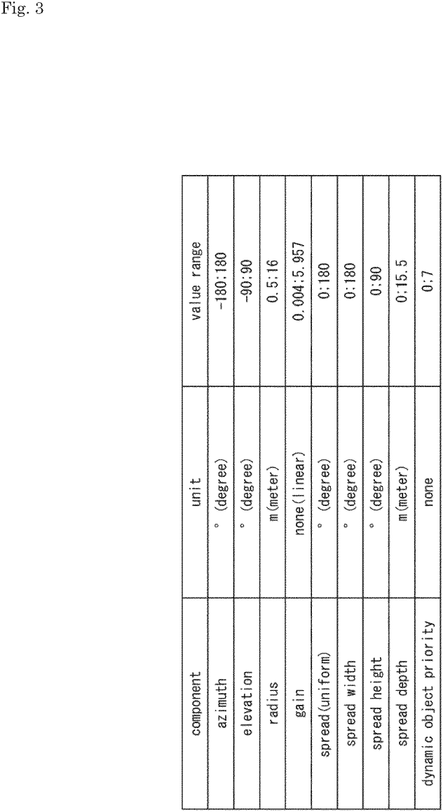

Each parameter constituting metadata is set to be a value within a value range which is a predetermined range illustrated in FIG. 3.

In the example in FIG. 3, a value range of each parameter constituting metadata is illustrated.

Note that, in FIG. 3, “spread”, “spread width”, “spread height”, and “spread depth” are parameters for spread processing and are examples of other parameters. In addition, “dynamic object priority” is a parameter indicating the priority of an object, and this parameter is also an example of other parameters.

For example, in this example, the value range of the horizontal angle (Azimuth) is from a lower limit value of -180 degrees to an upper limit value of 180 degrees.

In a case where the horizontal angle input to the quantization unit 21 exceeds the value range, that is, in a case where the horizontal angle falls outside the range, the horizontal angle is replaced with the lower limit value “-180” or the upper limit value “180” and then quantized. That is, when the input horizontal angle is a value larger than the upper limit value, the upper limit value “180” is set to be the horizontal angle after restriction (replacement), and when the horizontal angle is a value smaller than the lower limit value, the lower limit value “-180” is set to be the horizontal angle after restriction.

In addition, for example, the value range of the gain value (Gain) is from a lower limit value of 0.004 to an upper limit value of 5.957. In particular, here, the gain value is described as a linear value.

Returning to the description of FIG. 2, when parameters constituting metadata are quantized by the quantization unit 21, and the quantized parameters are obtained, the quantized parameters are encoded by the encoding unit 22, and the resulting encoded metadata is output. For example, the encoding unit 22 performs differential encoding on the quantized parameters to generate encoded metadata.

In addition, the core encoder 12 includes a time-frequency conversion unit 31, a quantization unit 32, and an encoding unit 33, and an audio signal of an object is input to the time-frequency conversion unit 31. In addition, the quantization unit 32 includes an auditory psychological parameter calculation unit 41 and a bit allocation unit 42.

In the core encoder 12, when encoding processing for the audio signal is started, the time-frequency conversion unit 31 first performs an MDCT, that is, time-frequency conversion on the input audio signal, and consequently, an MDCT coefficient which is frequency spectrum information is obtained.

Next, in the quantization unit 32, the MDCT coefficient obtained by the time-frequency conversion (MDCT) is quantized for each scale factor band, and consequently, a quantized MDCT coefficient is obtained.

Here, the scale factor band is a band (frequency band) obtained by bundling a plurality of sub-bands with a predetermined bandwidth which is the resolution of a quadrature mirror filter (QMF) analysis filter.

Specifically, in the quantization performed by the quantization unit 32, the auditory psychological parameter calculation unit 41 calculates auditory psychological parameters for considering human auditory characteristics (auditory masking) for the MDCT coefficient.

Further, in the bit allocation unit 42, the MDCT coefficient obtained by the time-frequency conversion and the auditory psychological parameters obtained by the auditory psychological parameter calculation unit 41 are used to perform bit allocation based on an auditory psychological model for calculating and evaluating quantized bits and quantized noise of each scale factor band.

Then, the bit allocation unit 42 quantizes the MDCT coefficient for each scale factor band on the basis of a result of the bit allocation and supplies the resulting quantized MDCT coefficient to the encoding unit 33.

In this manner, some of the quantized bits of the scale factor band where the quantized noise generated by the quantization of the MDCT coefficient is masked and is not perceived are allocated to the scale factor band where the quantized noise is easily perceived (turned). Thereby, it is possible to suppress deterioration of sound quality as a whole and perform efficient quantization. That is, it is possible to improve encoding efficiency.

Further, in the encoding unit 33, for example, context-based arithmetic encoding is performed on the quantized MDCT coefficient supplied from the bit allocation unit 42, and the resulting encoded audio data is output as encoded data of an audio signal.

As described above, metadata of an object and an audio signal are encoded by the meta-encoder 11 and the core encoder 12.

Incidentally, the MDCT coefficient used to calculate auditory psychological parameters is obtained by performing an MDCT, that is, time-frequency conversion, on the input audio signal.

However, when the actually encoded audio signal is decoded, rendered, and viewed, gain values of metadata are applied, and thus a discrepancy occurs between audio signals used at the time of calculating auditory psychological parameters and at the time of viewing.

For this reason, a reduction in encoding efficiency, such as using extra bits to prevent the generation of quantized noise which is not originally audible in auditory sensation for a predetermined scale factor band, may occur.

Consequently, in the present technology, auditory psychological parameters are calculated using a corrected MDCT coefficient to which gain values of metadata are applied, and thus it is possible to obtain auditory psychological parameters more adapted to the actual auditory sensation and to improve encoding efficiency.

### Configuration Example of Encoding Device

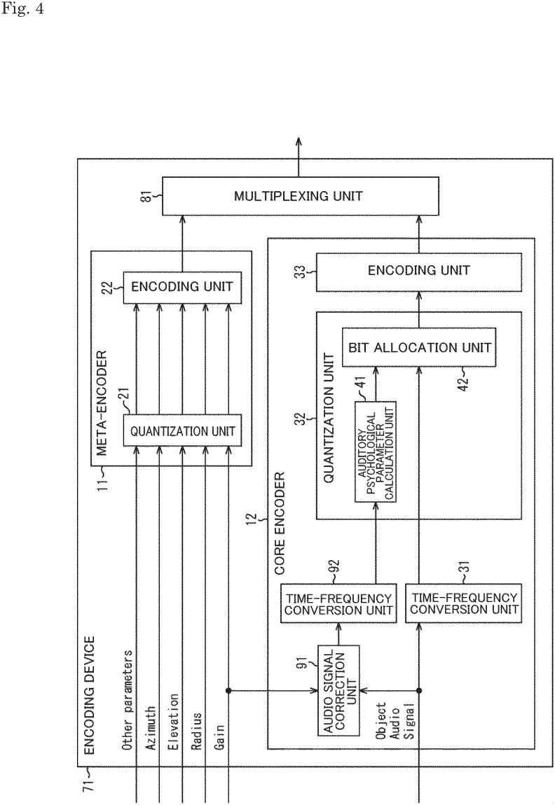

FIG. 4 is a diagram illustrating a configuration example of one embodiment of an encoding device to which the present technology is applied. Note that, in FIG. 4, portions corresponding to those in FIG. 2 are denoted by the same reference numerals and signs, and description thereof will be appropriately omitted.

An encoding device 71 illustrated in FIG. 4 is implemented by a signal processing device such as a server that distributes the content of an audio object and includes a meta-encoder 11, a core encoder 12, and a multiplexing unit 81.

Further, the meta-encoder 11 includes a quantization unit 21 and an encoding unit 22, and the core encoder 12 includes an audio signal correction unit 91, a time-frequency conversion unit 92, a time-frequency conversion unit 31, a quantization unit 32, and an encoding unit 33.

Further, the quantization unit 32 includes an auditory psychological parameter calculation unit 41 and a bit allocation unit 42.

The encoding device 71 is configured such that a multiplexing unit 81, an audio signal correction unit 91, and a time-frequency conversion unit 92 are newly added to the configuration illustrated in FIG. 2, and has the same configuration as that illustrated in FIG. 2 in other respects.

In the example of FIG. 4, the multiplexing unit 81 multiplexes encoded metadata supplied from the encoding unit 22 and encoded audio data supplied from the encoding unit 33 to generate and output a bitstream.

In addition, an audio signal of an object and gain values of the object which constitute metadata are supplied to the audio signal correction unit 91.

The audio signal correction unit 91 performs gain correction on the supplied audio signal on the basis of the supplied gain value, and supplies the audio signal having been subjected to the gain correction to the time-frequency conversion unit 92. For example, the audio signal correction unit 91 multiplies the audio signal by the gain value to perform gain correction of the audio signal. That is, here, correction is performed on the audio signal in a time domain.

The time-frequency conversion unit 92 performs an MDCT on the audio signal supplied from the audio signal correction unit 91 and supplies the resulting MDCT coefficient to the auditory psychological parameter calculation unit 41.

Note that, hereinafter, the audio signal obtained by the gain correction in the audio signal correction unit 91 is also specifically referred to as a corrected audio signal, and the MDCT coefficient obtained by the MDCT in the time-frequency conversion unit 92 is specifically referred to as a corrected MDCT coefficient.

Further, in this example, the MDCT coefficient obtained by the time-frequency conversion unit 31 is not supplied to the auditory psychological parameter calculation unit 41, and in the auditory psychological parameter calculation unit 41, auditory psychological parameters are calculated on the basis of the corrected MDCT coefficient supplied from the time-frequency conversion unit 92.

In the encoding device 71, the audio signal correction unit 91 at the head performs gain correction on an input audio signal of an object by applying gain values included in metadata in the same manner as during rendering.

Thereafter, the time-frequency conversion unit 92 performs an MDCT on the corrected audio signal obtained by the gain correction separately from that for bit allocation to obtain a corrected MDCT coefficient.

Then, finally, auditory psychological parameters are calculated by the auditory psychological parameter calculation unit 41 on the basis of the corrected MDCT coefficient, thereby obtaining auditory psychological parameters more adapted to the actual auditory sensation than in the case of FIG. 2.

This is because a sound based on the corrected audio signal is closer to a sound based on a signal obtained by rendering on the decoding side than a sound based on the original audio signal. In this manner, quantized bits are more appropriately allocated to each scale factor band, and encoding efficiency can be improved.

Note that, although an example in which gain values of metadata before quantization are used for gain correction in the audio signal correction unit 91 has been described here, gain values after encoding or quantization may be supplied to the audio signal correction unit 91 and used for gain correction.

In such a case, the gain values after encoding or quantization are decoded or inversely quantized in the audio signal correction unit 91, and gain correction of an audio signal is performed on the basis of gain values obtained as a result of the decoding or quantization to obtain a corrected audio signal.

### Description of Encoding Processing

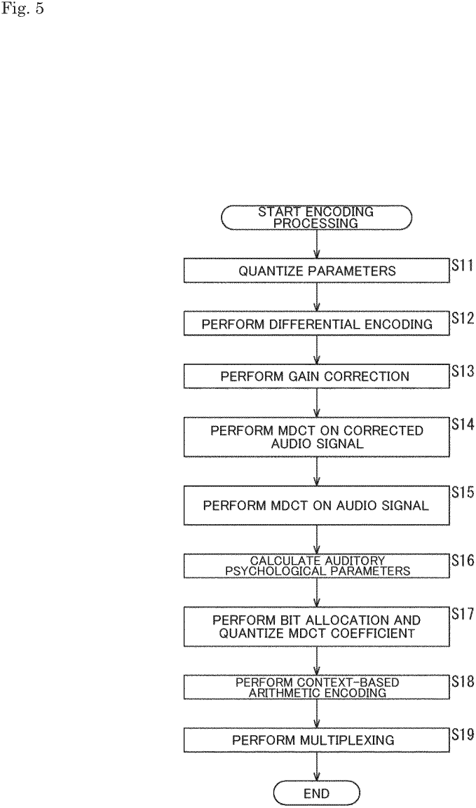

Next, operations of the encoding device 71 illustrated in FIG. 4 will be described. That is, encoding processing performed by the encoding device 71 will be described below with reference to a flowchart of FIG. 5.

In step S11, the quantization unit 21 quantizes parameters as supplied metadata and supplies the resulting quantized parameters to the encoding unit 22.

At this time, the quantization unit 21 performs quantization after replacing parameters larger than a predetermined value range with an upper limit value of the value range, and similarly performs quantization after replacing parameters smaller than the value range with a lower limit value.

In step S12, the encoding unit 22 performs differential encoding on the quantized parameters supplied from the quantization unit 21 and supplies the resulting encoded metadata to the multiplexing unit 81.

In step S13, the audio signal correction unit 91 performs gain correction based on gain values of the supplied metadata on a supplied audio signal of an object and supplies the resulting corrected audio signal to the time-frequency conversion unit 92.

In step S14, the time-frequency conversion unit 92 performs MDCT (time-frequency conversion) on the corrected audio signal supplied from the audio signal correction unit 91 and supplies the resulting corrected MDCT coefficient to the auditory psychological parameter calculation unit 41.

In step S15, the time-frequency conversion unit 31 performs MDCT (time-frequency conversion) on the supplied audio signal of the object and supplies the resulting MDCT coefficient to the bit allocation unit 42.

In step S16, the auditory psychological parameter calculation unit 41 calculates auditory psychological parameters on the basis of the corrected MDCT coefficient supplied from the time-frequency conversion unit 92 and supplies the calculated auditory psychological parameters to the bit allocation unit 42.

In step S17, the bit allocation unit 42 performs bit allocation based on an auditory psychological model on the basis of the auditory psychological parameters supplied from the auditory psychological parameter calculation unit 41 and the MDCT coefficient supplied from the time-frequency conversion unit 31, and quantizes the MDCT coefficient for each scale factor band on the basis of the results. The bit allocation unit 42 supplies the quantized MDCT coefficient obtained by the quantization to the encoding unit 33.

In step S18, the encoding unit 33 performs context-based arithmetic encoding on the quantized MDCT coefficient supplied from the bit allocation unit 42, and supplies the resulting encoded audio data to the multiplexing unit 81.

In step S19, the multiplexing unit 81 multiplexes the encoded metadata supplied from the encoding unit 22 and the encoded audio data supplied from the encoding unit 33 to generate and output a bitstream.

When the bitstream is output in this manner, the encoding processing is terminated.

As described above, the encoding device 71 corrects the audio signal on the basis of the gain values of the metadata before encoding and calculates auditory psychological parameters on the basis of the resulting corrected audio signal. In this manner, it is possible to obtain auditory psychological parameters that are more adapted to the actual auditory sensation and to improve encoding efficiency.

### Second Embodiment

### Configuration Example of Encoding Device

Incidentally, the encoding device 71 illustrated in FIG. 4 needs to perform MDCT twice, and thus a computational load (the amount of computation) increases. Consequently, the amount of computation may be reduced by correcting an MDCT coefficient (audio signals) in a frequency domain.

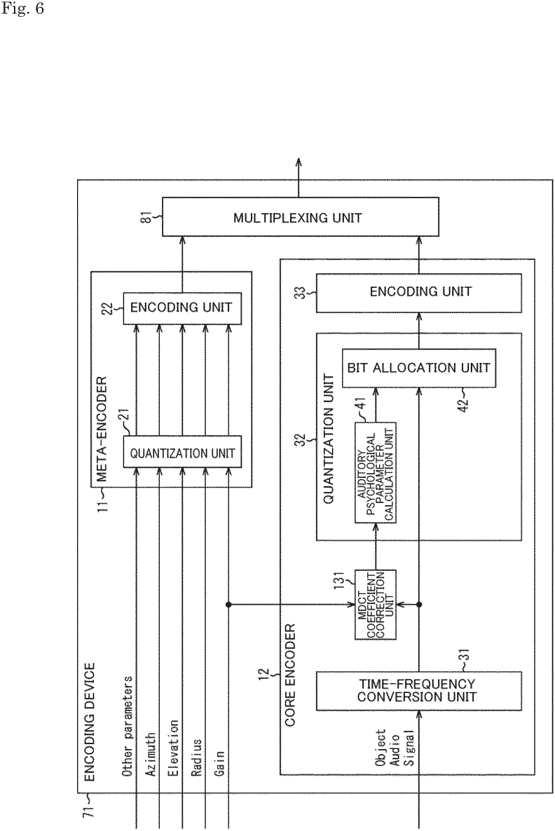

In such a case, the encoding device 71 is configured, for example, as illustrated in FIG. 6. Note that, in FIG. 6, portions corresponding to those in FIG. 4 are denoted by the same reference numerals and signs, and description thereof will be appropriately omitted.

The encoding device 71 illustrated in FIG. 6 includes a meta-encoder 11, a core encoder 12, and a multiplexing unit 81.

Further, the meta-encoder 11 includes a quantization unit 21 and an encoding unit 22, and the core encoder 12 includes a time-frequency conversion unit 31, an MDCT coefficient correction unit 131, a quantization unit 32, and an encoding unit 33. Further, the quantization unit 32 includes an auditory psychological parameter calculation unit 41 and a bit allocation unit 42.

The configuration of the encoding device 71 illustrated in FIG. 6 differs from the configuration of the encoding device 71 in FIG. 4 in that the MDCT coefficient correction unit 131 is provided instead of the time-frequency conversion unit 92 and the audio signal correction unit 91, and is the same as the configuration of the encoding device 71 in FIG. 4 in other respects.

In this example, first, the time-frequency conversion unit 31 performs MDCT on an audio signal of an object, and the resulting MDCT coefficient is supplied to the MDCT coefficient correction unit 131 and the bit allocation unit 42.

Then, the MDCT coefficient correction unit 131 corrects the MDCT coefficient supplied from the time-frequency conversion unit 31 on the basis of gain values of the supplied metadata, and the resulting corrected MDCT coefficient is supplied to the auditory psychological parameter calculation unit 41.

For example, the MDCT coefficient correction unit 131 multiplies the MDCT coefficient by the gain values to correct the MDCT coefficient. Thereby, gain correction of the audio signal is performed in a frequency domain.

In a case where gain correction is performed in the frequency domain in this manner, the reproducibility of the gain correction is slightly lower than in the case of the first embodiment in which gain correction is performed on the basis of gain values of metadata in the same manner as the actual rendering in a time domain. That is, the corrected MDCT coefficient is not as accurate as in the first embodiment.

However, by calculating the auditory psychological parameters by the auditory psychological parameter calculation unit 41 on the basis of the corrected MDCT coefficient, it is possible to obtain auditory psychological parameters more adapted to the actual auditory sensation than in the case of FIG. 2 with substantially the same amount of computation as in the case of FIG. 2. Thereby, it is possible to improve encoding efficiency while keeping a computational load low.

Note that, although an example in which gain values of metadata before quantization are used for the correction of an MDCT coefficient has been described in FIG. 6, gain values after encoding or quantization may be used.

In such a case, the MDCT coefficient correction unit 131 corrects an MDCT coefficient on the basis of gain values obtained as a result of decoding or inverse quantization performed on gain values after encoding or quantization to obtain a corrected MDCT coefficient.

### Description of Encoding Processing

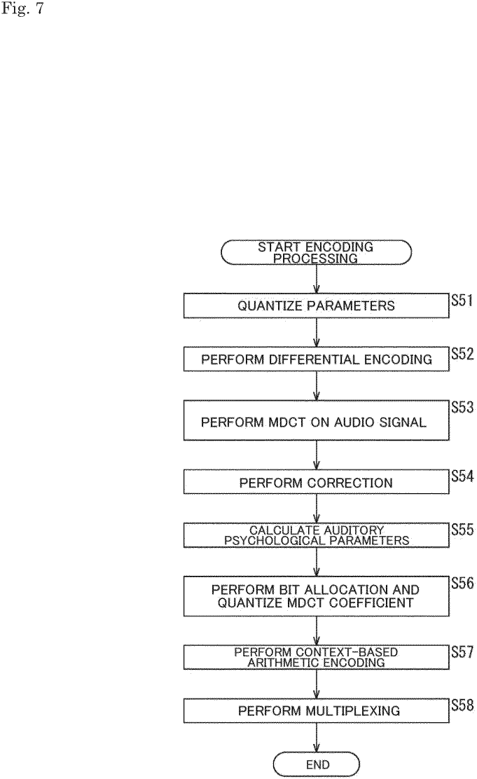

Next, operations of the encoding device 71 illustrated in FIG. 6 will be described. That is, encoding processing performed by the encoding device 71 in FIG. 6 will be described below with reference to a flowchart of FIG. 7.

Note that the processes of steps S51 and S52 are the same as the processes of steps S11 and S12 in FIG. 5, and thus description thereof will be omitted.

In step S53, the time-frequency conversion unit 31 performs MDCT on the supplied audio signal of an object, and supplies the resulting MDCT coefficient to the MDCT coefficient correction unit 131 and the bit allocation unit 42.

In step S54, the MDCT coefficient correction unit 131 corrects the MDCT coefficient supplied from the time-frequency conversion unit 31 on the basis of the gain values of the supplied metadata, and supplies the resulting corrected MDCT coefficient to the auditory psychological parameter calculation unit 41.

When the corrected MDCT coefficient is obtained in this manner, the processes of steps S55 to S58 are performed thereafter, and the encoding processing is terminated. However, these processes are the same as the processes of steps S16 to S19 in FIG. 5, and thus description thereof will be omitted. However, in step S55, the auditory psychological parameter calculation unit 41 calculates auditory psychological parameters on the basis of the corrected MDCT coefficient supplied from the MDCT coefficient correction unit 131.

As described above, the encoding device 71 corrects the audio signal (MDCT coefficient) in a frequency domain and calculates auditory psychological parameters on the basis of the obtained corrected MDCT coefficient.

In this manner, it is possible to obtain auditory psychological parameters that are more adapted to the actual auditory sensation even with a small amount of computation and to improve encoding efficiency.

### Third Embodiment

### Configuration Example of Encoding Device

Incidentally, in the actual 3D Audio content, gain values of metadata before encoding are not necessarily within a specification range of MPEG-H.

That is, for example, when a content is created, it is conceivable that gain values of metadata are set to be values greater than 5.957 (≈15.50 dB) in order to match a sound volume of an object of which a waveform level is extremely low with sound volumes of other objects. In contrast, the gain values of the metadata may be values smaller than 0.004 (≈49.76 dB) for an unnecessary sound.

When the gain values of the metadata are limited to an upper limit value or a lower limit value of the value range illustrated in FIG. 3 in a case where such a content is encoded and decoded in an MPEG-H format, a sound which is actually heard during reproduction is different from what a content creator intended.

Consequently, in a case where the gain values of the metadata fall outside the range of the MPEG-H specifications, preprocessing for modifying the gain values of the metadata and the audio signal so as to conform to the MPEG-H specifications may be performed to reproduce a sound close to the content creator’s intention.

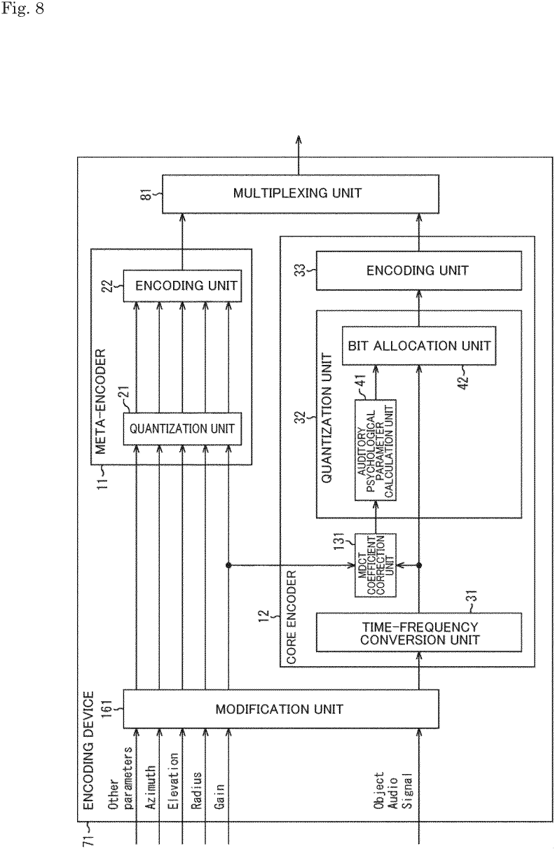

In such a case, the encoding device 71 is configured, for example, as illustrated in FIG. 8. Note that, in FIG. 8, portions corresponding to those in FIG. 6 are denoted by the same reference numerals and signs, and description thereof will be appropriately omitted.

The encoding device 71 illustrated in FIG. 8 includes a modification unit 161, a meta-encoder 11, a core encoder 12, and a multiplexing unit 81.

Further, the meta-encoder 11 includes a quantization unit 21 and an encoding unit 22, and the core encoder 12 includes a time-frequency conversion unit 31, an MDCT coefficient correction unit 131, a quantization unit 32, and an encoding unit 33. Further, the quantization unit 32 includes an auditory psychological parameter calculation unit 41 and a bit allocation unit 42.

The configuration of the encoding device 71 illustrated in FIG. 8 differs from the configuration of the encoding device 71 in FIG. 6 in that the modification unit 161 is newly provided, and is the same as the configuration of the encoding device 71 in FIG. 6 in other respects.

In the example illustrated in FIG. 8, metadata and audio signals of objects which constitute a content are supplied to the modification unit 161.

Before encoding, the modification unit 161 checks (confirms) whether there is a gain value falling outside the specification range of MPEG-H, that is, outside the value range described above, among the gain values of the supplied metadata.

Then, in a case where there is a gain value falling outside the value range, the modification unit 161 performs modification processing of a gain value and an audio signal based on the MPEG-H specification as preprocessing with respect to the gain value and the audio signal corresponding to the gain value.

Specifically, the modification unit 161 modifies the gain value falling outside the value range (the specification range of MPEG-H) to the upper limit value or the lower limit value of the value range to obtain a modified gain value.

In other words, in a case where the gain value is greater than the upper limit value of the value range, the upper limit value is set to be a modified gain value which is a gain value after modification, and in a case where the gain value is smaller than the lower limit value of the value range, the lower limit value is set to be a modified gain value.

Note that the modification unit 161 does not modify (change) parameters other than the gain value among the plurality of parameters as metadata.

Further, the modification unit 161 performs gain correction on the supplied audio signal of the object on the basis of the gain value before the modification and the modified gain value to obtain a modified audio signal. That is, the audio signal is modified (gain correction) on the basis of a difference between the gain value before the modification and the modified gain value.

At this time, gain correction is performed on the audio signal so that an output of rendering based on the metadata (gain value) and audio signal before the modification and an output of rendering based on the metadata (modified gain value) and modified audio signal after the modification are equal to each other.

The modification unit 161 performs the above-described modification of the gain value and the audio signal as preprocessing, supplies data constituted by a gain value modified as necessary and parameters other than the gain value of the supplied metadata to the quantization unit 21 as metadata after the modification, and supplies the gain value modified as necessary to the MDCT coefficient correction unit 131.

Further, the modification unit 161 supplies the audio signal modified as necessary to the time-frequency conversion unit 31.

Note that, hereinafter, in order to simplify the description, metadata and a gain value output from the modification unit 161 will also be referred to as modified metadata and a modified gain value, regardless of whether or not modification has been performed. Similarly, an audio signal output from the modification unit 161 is also referred to as a modified audio signal.

Thus, in this example, modified metadata is an input of the meta-encoder 11, and a modified audio signal and a modified gain value are inputs of the core encoder 12.

In this manner, a gain value is not substantially limited by the MPEG-H specifications, and thus it is possible to obtain a rendering result according to the content creator’s intention.

The meta-encoder 11 and the core encoder 12 perform processing similar to the example illustrated in FIG. 6 using modified metadata and a modified audio signal as inputs.

That is, for example, in the core encoder 12, the time-frequency conversion unit 31 performs MDCT on the modified audio signal, and the resulting MDCT coefficient is supplied to the MDCT coefficient correction unit 131 and the bit allocation unit 42.

Further, the MDCT coefficient correction unit 131 performs correction on the MDCT coefficient supplied from the time-frequency conversion unit 31 on the basis of the modified gain value supplied from the modification unit 161, and the corrected MDCT coefficient is supplied to the auditory psychological parameter calculation unit 41.

Note that, although an example in which an MDCT coefficient is corrected in a frequency domain has been described here, gain correction of a modified audio signal is performed using a modified gain value in a time domain as in the first embodiment, and then corrected MDCT coefficient may be obtained by MDCT.

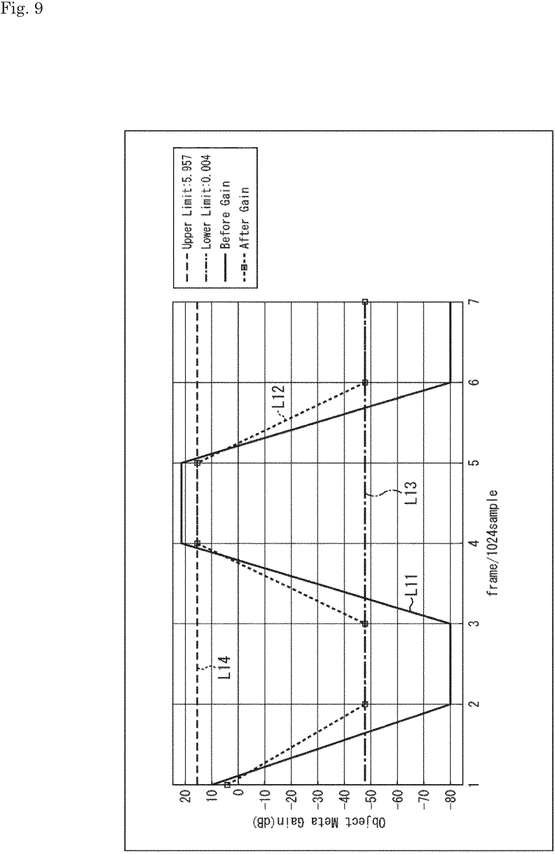

Here, a specific example of modification of a gain value of an audio signal will be described with reference to FIGS. 9 to 11.

FIG. 9 illustrates gain values for each frame of metadata of a predetermined object. Note that, in FIG. 9, the horizontal axis indicates a frame, and the vertical axis indicates a gain value.

Particularly, in this example, a polygonal line L11 indicates a gain value in each frame before modification, and a polygonal line L12 indicates a gain value in each frame after modification, that is, a modified gain value.

In addition, a straight line L13 indicates a specification range of MPEG-H, that is, a lower limit value (0.004 (≈-49.76 dB)) of the above-mentioned value range, and a straight line L14 indicates an upper limit value of the specification range of MPEG-H (5.957 (≈15.50 dB)).

Here, for example, a gain value before modification in a frame “2” is a value smaller than the lower limit value indicated by the straight line L13, and thus the gain value is replaced with the lower limit value to obtain a modified gain value. In addition, for example, a gain value before modification in a frame “4” is a value larger than the upper limit value indicated by the straight line L14, and thus the gain value is replaced with the upper limit value to obtain a modified gain value.

In this manner, the modification of a gain value is appropriately performed, and thus a modified gain value in each frame is set to a value within the specification range (value range) of MPEG-H.

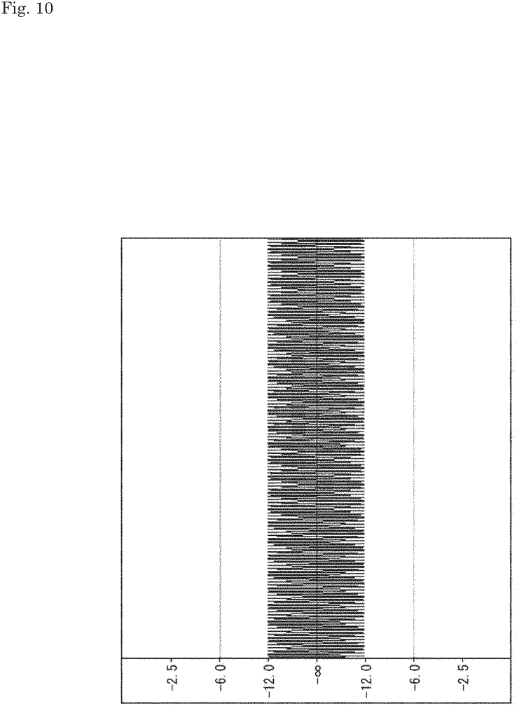

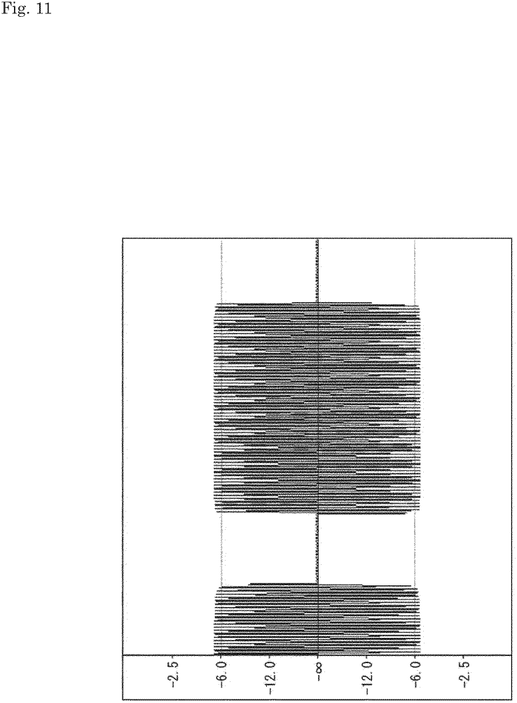

In addition, FIG. 10 illustrates an audio signal before modification performed by the modification unit 161, and FIG. 11 illustrates a modified audio signal obtained by modifying the audio signal illustrated in FIG. 10. Note that, in FIGS. 10 and 11, the horizontal axis indicates time, and the vertical axis indicates a signal level.

As illustrated in FIG. 10, the signal level of an audio signal before modification is a fixed level regardless of time.

When the modification unit 161 performs gain correction based on a gain value and a modified gain value on such an audio signal, a modified audio signal having a signal level varying at each time as illustrated in FIG. 11, that is, having a signal level which is not fixed is obtained.

In particular, in FIG. 11, it can be understood that the signal level of a modified audio signal has been more increased than before modification in a sample affected by a decrease in a gain value of metadata due to the modification, that is, by replacement with an upper limit value.

This is because it is necessary to increase the audio signal by an amount corresponding to the decrease in the gain value in order to make outputs of rendering the same before and after the modification.

In contrast, it can be seen that the signal level of a modified audio signal has been more reduced than before modification in a sample affected by an increase in a gain value of metadata due to the modification, that is, by replacement with a lower limit value.

### Description of Encoding Processing

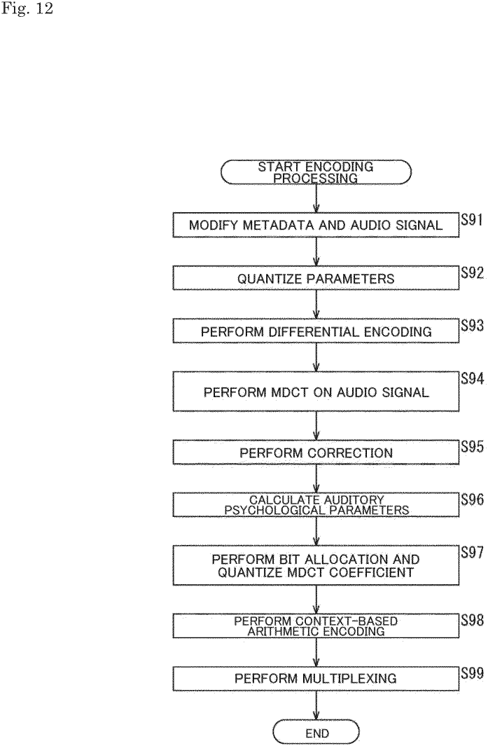

Next, operations of the encoding device 71 illustrated in FIG. 8 will be described. That is, encoding processing performed by the encoding device 71 in FIG. 8 will be described below with reference to a flowchart of FIG. 12.

In step S91, the modification unit 161 modifies metadata, more specifically, a gain value of the metadata and a supplied audio signal of an object as necessary, in accordance with the supplied gain value of the metadata of the object.

That is, in a case where the gain value of the metadata falls outside the specification range of MPEG-H, that is, is a value falling outside the value range, the modification unit 161 performs modification for replacing the gain value with the upper limit value or the lower limit value of the value range and modifies the audio signal on the basis of the gain values before and after the modification.

The modification unit 161 supplies the modified metadata constituted by the modified gain value obtained by appropriately performing modification and parameters of the metadata other than the supplied gain values to the quantization unit 21 and supplies the modified gain values to the MDCT coefficient correction unit 131.

Further, the modification unit 161 supplies the modified audio signal obtained by appropriately performing modification to the time-frequency conversion unit 31.

When the modified metadata and the modified audio signal are obtained in this manner, the processes of steps S92 to S99 are performed thereafter, and the encoding processing is terminated. However, these processes are the same as the processes of steps S51 to S58 in FIG. 7, and thus description thereof will be omitted.

However, in steps S92 and S93, the modified metadata is quantized and encoded, and in step S94, MDCT is performed on the modified audio signal.

Further, in step S95, the MDCT coefficient is corrected on the basis of the MDCT coefficient obtained in step S94 and the modified gain values supplied from the modification unit 161, and the resulting corrected MDCT coefficient is supplied to the auditory psychological parameter calculation unit 41.

As described above, the encoding device 71 modifies the input metadata and audio signal as necessary and then encodes them.

In this manner, the gain values are not substantially limited by the specifications of MPEG-H, and rendering results can be obtained as intended by the content creator.

### Fourth Embodiment

### Regarding Correction of Gain Value According to Auditory Characteristics

Further, it is also possible to correct an audio signal used for calculation of auditory psychological parameters in accordance with auditory characteristics related to the direction of arrival of a sound from a sound source.

For example, as characteristics of hearing, the perception of loudness of a sound varies depending on the direction of arrival of a sound from a sound source.

That is, even for the same object, an auditory sound volume varies in a case where sound sources are located in respective directions, that is, on the front, lateral, upper, and lower sides of a listener. For this reason, in order to calculate the auditory psychological parameters adapted to the actual auditory sensation, it is necessary to perform gain correction based on a difference in sound pressure sensitivity depending on the direction of arrival of a sound from a sound source.

Here, the difference in sound pressure sensitivity depending on the direction of arrival of a sound and the correction according to the sound pressure sensitivity are described.

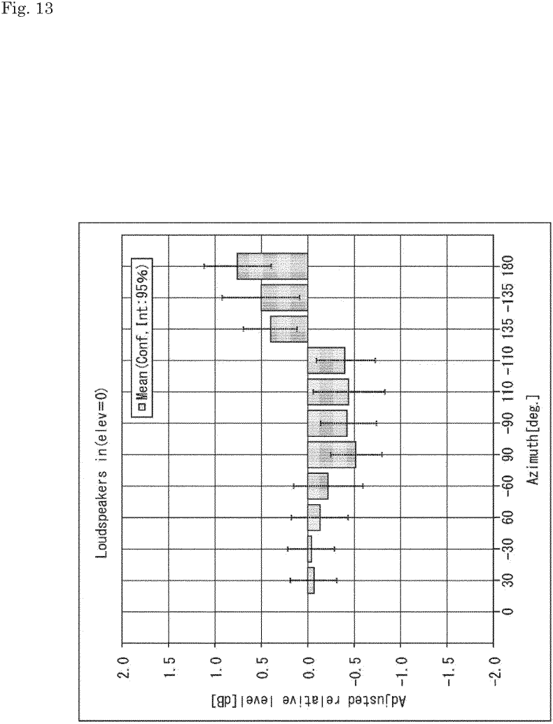

FIG. 13 illustrates an example of the amount of gain correction when gain correction of pink noise is performed so that an auditory sound volume is felt the same at the time of reproducing the same pink noise from different directions, on the basis of an auditory sound volume when certain pink noise is reproduced directly in front of the listener.

Note that, in FIG. 13, the vertical axis indicates the amount of gain correction, and the horizontal axis indicates Azimuth (horizontal angle) which is an angle in the horizontal direction indicating the position of a sound source as seen from the listener.

For example, Azimuth indicating the direction of the right front side as seen from the listener is 0 degrees, Azimuth indicating the right lateral direction as seen from the listener, that is, the lateral side, is ±90 degrees, and Azimuth indicating the back side, that is, the direction right behind of the listener, is 180 degrees. In particular, the left direction as seen from the listener is the positive direction of Azimuth.

This example shows an average value of the amount of gain correction for each Azimuth obtained from results of experiments performed on a plurality of listeners, and particularly, a range represented by a dashed line in each Azimuth indicates a 95% confidence interval.

For example, when pink noise is reproduced on the lateral side (Azimuth = ±90 degrees), it can be understood that a listener feels that the same volume of sound as when the pink noise is reproduced in the direction of the front side of the listener is heard by slightly decreasing a gain.

In addition, for example, when pink noise is reproduced on the lateral side (Azimuth = 180 degrees), it can be understood that the listener feels that the same volume of sound as when the pink noise is reproduced in the direction of the front side of the listener is heard by slightly increasing a gain.

That is, for a certain object sound source, in a case where a gain of a sound of the object sound source is slightly decreased when the localization position of the object sound source is on the lateral side of the listener, and in a case where the gain of the sound of the object sound source is slightly increased when the localization position of the object sound source is on the lateral side of the listener, it is possible to make the listener feel that the same volume of sound is heard.

Consequently, when the amount of correction of a gain value for an object is determined on the basis of auditory characteristics from positional information of the object, and the gain value is corrected with the determined amount of correction, it is possible to obtain auditory psychological parameters taking the auditory characteristics into consideration.

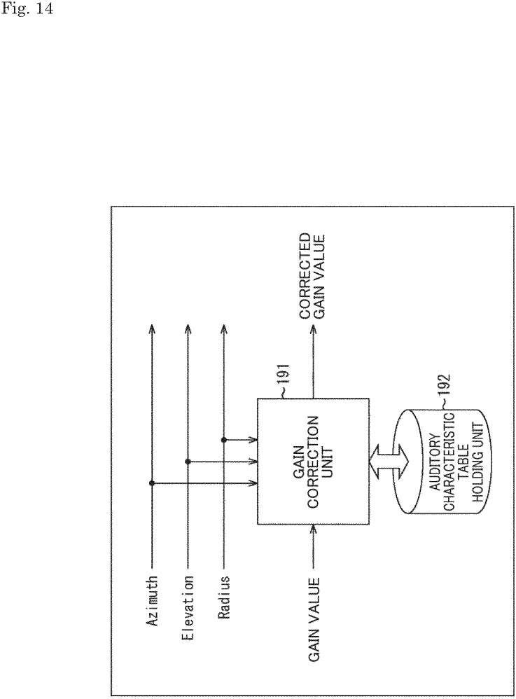

In such a case, for example, as illustrated in FIG. 14, a gain correction unit 191 and an auditory characteristic table holding unit 192 may be provided.

Gain values included in metadata of an object are supplied to the gain correction unit 191, and the horizontal angle (Azimuth), the vertical angle (Elevation), and the distance (Radius) as positional information included in the metadata of the object are supplied thereto. Note that a gain value is assumed to be 1.0 here for the sake of simplicity of description.

The gain correction unit 191 determines a gain correction value indicating the amount of gain correction for correcting a gain value of an object, on the basis of the positional information as the supplied metadata and an auditory characteristic table held in the auditory characteristic table holding unit 192.

In addition, the gain correction unit 191 corrects the supplied gain value on the basis of the determined gain correction value, and outputs the resulting gain value as a corrected gain value.

In other words, the gain correction unit 191 determines a gain correction value in accordance with the direction of an object as seen from a listener (the direction of arrival of a sound), which is indicated by the positional information, to thereby determine a corrected gain value for gain correction of an audio signal used for calculation of auditory psychological parameters.

The auditory characteristic table holding unit 192 holds an auditory characteristic table indicating auditory characteristics related to the direction of arrival of a sound from a sound source, and supplies a gain correction value indicated by the auditory characteristic table to the gain correction unit 191 as necessary.

Here, the auditory characteristic table is a table in which the direction of arrival of a sound from an object, which is a sound source, to the listener, that is, the direction (position) of the sound source as seen from the listener, and a gain correction value corresponding to the direction are associated with each other. In other words, the auditory characteristic table is an auditory characteristic indicating the amount of gain correction that makes an auditory sound volume constant with respect to the direction of arrival of the sound from the sound source.

A gain correction value indicated by the auditory characteristic table is determined in accordance with human auditory characteristics with respect to the direction of arrival of a sound, and particularly, is the amount of gain correction that makes an auditory sound volume constant regardless of the direction of arrival of the sound. In other words, the gain correction value is a correction value for correcting a gain value based on auditory characteristics related to the direction of arrival of the sound.

Thus, when an audio signal of an object is subjected to gain correction using a corrected gain value obtained by correcting a gain value using the gain correction value indicated by the auditory characteristic table, sounds of the same object are heard at the same volume regardless of the position of the object.

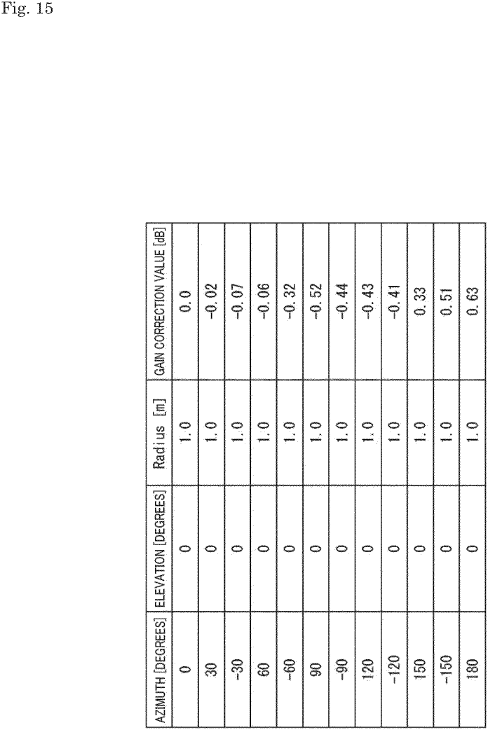

Here, FIG. 15 illustrates an example of the auditory characteristic table.

In the example illustrated in FIG. 15, a gain correction value is associated with the position of an object determined by the horizontal angle (Azimuth), the vertical angle (Elevation), and the distance (Radius), that is, the direction of the object.

Specifically, in this example, all vertical angles (Elevation) and distances (Radius) are 0 and 1.0, the position of the object in the vertical direction is the same height as a listener, and a distance from the listener to the object is assumed to be constant at all times.

In the example of FIG. 15, when an object, which is a sound source, is behind the listener, such as when the horizontal angle is 180 degrees, a gain correction value is larger than when the object is in front of the listener, such as when the horizontal angle is 0 degrees or 30 degrees.

Further, a specific example of gain value correction performed by the gain correction unit 191 when the auditory characteristic table holding unit 192 holds the auditory characteristic table illustrated in FIG. 15 will be described.

For example, when it is assumed that the horizontal angle, vertical angle, and distance, which are parameters of metadata of the object, are 90 degrees, 0 degrees, and 1.0 m, respectively, a gain correction value corresponding to the position of the object is -0.52 dB as illustrated in FIG. 15.

Thus, the gain correction unit 191 calculates the following Equation (1) on the basis of the gain correction value “-0.52 dB” read from the auditory characteristic table and a gain value “1.0” to obtain a corrected gain value “0.94”.

$$1.0 \times {10}^{- 0.52 / 20} ≅ 0.94$$

Similarly, for example, when it is assumed that the horizontal angle, vertical angle, and distance indicating the position of the object are -150 degrees, 0 degrees, and 1.0 m, respectively, a gain correction value corresponding to the position of the object is 0.51 dB as illustrated in FIG. 15.

Thus, the gain correction unit 191 calculates the following Equation (2) on the basis of the gain correction value “0.51 dB” read from the auditory characteristic table and a gain value “1.0” to obtain a corrected gain value “1.06”.

$$1.0 \times {10}^{0.51 / 20} ≅ 1.06$$

Note that an example in which a gain correction value determined on the basis of two-dimensional auditory characteristics taking only the horizontal direction into consideration is used has been described in FIG. 15. That is, an example in which an auditory characteristic table (hereinafter also referred to as a two-dimensional auditory characteristic table) generated on the basis of the two-dimensional auditory characteristics is used has been described.

However, a gain value may be corrected using a gain correction value determined on the basis of three-dimensional auditory characteristics taking not only the horizontal direction but also characteristics in the vertical direction into consideration.

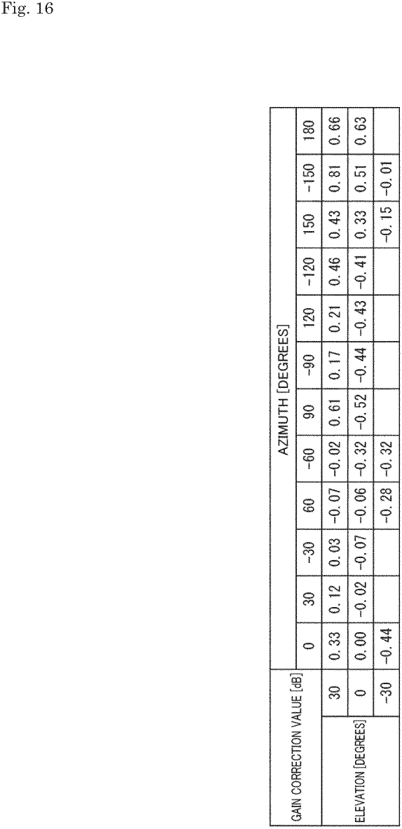

In such a case, for example, an auditory characteristic table illustrated in FIG. 16 can be used.

In the example illustrated in FIG. 16, a gain correction value is associated with the position of an object determined by the horizontal angle (Azimuth), the vertical angle (Elevation), and the distance (Radius), that is, the direction of the object.

Specifically, in this example, a distance is 1.0 for all combinations of horizontal angles and vertical angles.

Hereinafter, an auditory characteristic table generated on the basis of three-dimensional auditory characteristics with respect to the direction of arrival of a sound as illustrated in FIG. 16 will also particularly be referred to as a three-dimensional auditory characteristic table.

Here, a specific example of correction of a gain value by the gain correction unit 191 in a case where the auditory characteristic table holding unit 192 holds the auditory characteristic table illustrated in FIG. 16 is described.

For example, when it is assumed that a horizontal angle, a vertical angle, and a distance indicating the position of an object are 60 degrees, 30 degrees, and 1.0 m, respectively, a gain correction value corresponding to the position of the object is -0.07 dB as illustrated in FIG. 16.

Thus, the gain correction unit 191 calculates the following Equation (3) on the basis of a gain correction value “-0.07 dB” read from the auditory characteristic table and a gain value “1.0” to obtain a corrected gain value “0.99”.

$$1.0 \times {10}^{- 0.07 / 20} ≅ 0.99$$

Note that, in the specific example of calculation of a corrected gain value described above, the gain correction value based on the auditory characteristics determined with respect to the position (direction) of the object is prepared in advance. That is, an example in which a gain correction value corresponding to the positional information of the object is stored in the auditory characteristic table has been described.

However, the position of the object is not necessarily a position where the corresponding gain correction value is stored in the auditory characteristic table.

Specifically, for example, it is assumed that the auditory characteristic table shown in FIG. 16 is held in the auditory characteristic table holding unit 192, and a horizontal angle, vertical angle, and distance as positional information are -120 degrees, 15 degrees, and 1.0 m, respectively.

In this case, the auditory characteristic table of FIG. 16 does not store a gain correction value corresponding to a horizontal angle “-120”, a vertical angle “15”, and a distance “1.0”.

Consequently, in a case where there is no gain correction value corresponding to a position indicated by positional information in the auditory characteristic table, the gain correction unit 191 may calculate a gain correction value for a desired position by interpolation processing or the like by using gain correction values for a plurality of positions having corresponding gain correction values, the plurality of positions being adjacent to the position indicated by the positional information. In other words, interpolation processing or the like is performed on the basis of gain correction values associated with a plurality of positions in the vicinity of the position indicated by the positional information, and thus a gain correction value for the position indicated by the positional information is obtained.

For example, there is a method using vector base amplitude panning (VBAP) as one of gain correction value interpolation methods.

VBAP (3-point VBAP) is an amplitude panning technique which is often used in three-dimensional spatial audio rendering.

In VBAP, the position of a virtual speaker can be arbitrarily changed by giving a weighted gain to each of three real speakers in the vicinity of an arbitrary virtual speaker to reproduce a sound source signal.

At this time, a gain vg1, a gain vg2, and a gain vg3 of the real speakers are obtained such that the orientation of a composition vector obtained by weighting and adding vectors L1, L2, and L3 in three directions from a hearing position to the real speakers with the gains given to the real speakers matches the orientation (Lp) of the virtual speaker. Specifically, when the orientation of the virtual speaker, that is, a vector from the hearing position to the virtual speaker is set to be a vector Lp, the gains vg1 to vg3 that satisfy the following Equation (4) are obtained.

$$\text{Lp=L1*vg1+L2*vg2+L3*vg3}$$

Here, the positions of the three real speakers described above are assumed to be positions where there are three gain correction values CG1, CG2, and CG3 corresponding to the auditory characteristic table. In addition, the position of the virtual speaker described above is assumed to be an arbitrary position where there is no gain correction value corresponding to the auditory characteristic table.

At this time, it is possible to obtain a gain correction value CGp at the position of the virtual speaker by calculating the following Equation (5).

$$\begin{matrix}\text{Ri=} \text{vgi} / \sqrt{\left(\text{vg} 1 * \text{vg} 1 + \text{vg} 2 * \text{vg} 2 + \text{vg} 3 * \text{vg} 3\right)} \text{i} = 1 , 2 , 3 \\ \text{CGp=R1*CG1+R2*CG2+R3*CG3}\end{matrix}$$

In Equation (5), first, the above-described weighted gains vg1, vg2, and vg3 obtained by VBAP are normalized such that the sum of squares is set to 1, thereby obtaining ratios R1, R2, and R3.

Then, a composition gain obtained by weighting and adding the gain correction values CG1, CG2, and CG3 for the position of the real speaker based on the obtained ratios R1, R2, and R3 is set to be the gain correction value CGp at the position of the virtual speaker.

Specifically, a mesh is partitioned at a plurality of positions for which gain correction values are prepared in a three-dimensional space. That is, for example, when it is assumed that gain correction values for three positions in the three-dimensional space are prepared, one triangular region with the three positions as vertices is set to be one mesh.

When the three-dimensional space is partitioned into a plurality of meshes in this manner, a desired position for obtaining a gain correction value is set as a target position, and a mesh including the target position is specified.

In addition, a coefficient multiplied by position vectors indicating three vertex positions constituting the specified mesh at the time of representing a position vector indicating a target position by multiplication and addition of the position vectors indicating the three vertex positions is obtained by VBAP.

Then, the three coefficients obtained in this manner are normalized such that the sum of squares is set to 1, each of the normalized coefficients is multiplied by each of the gain correction values for the three vertex positions of the mesh including the target position, and the sum of the gain correction values multiplied by the coefficients is calculated as a gain correction value for the target position. In addition, the normalization may be performed by any method such as making the sum or the sum of cubes or more equal to one.

Note that the gain correction value interpolation method is not limited to interpolation using VBAP, and any of other methods may be used.

For example, an average value of gain correction values for a plurality of positions, such as N positions (for example, N = 5) in the vicinity of the target position among the positions where there are gain correction values in the auditory characteristic table, may be used as the gain correction value for the target position.

Further, for example, a gain correction value for a position where a gain correction value is prepared (stored), which is closest to the target position among the positions where there are gain correction values in the auditory characteristic table, may be used as the gain correction value for the target position.

Incidentally, in the auditory characteristic table illustrated in FIG. 16, one gain correction value is prepared for each position. In other words, gain correction values are uniform at all frequencies.

However, it is also known that a subjective difference in sound pressure sensitivity depending on a direction changes depending on a frequency. Consequently, a gain correction value may be prepared for every plurality of frequencies for one position.

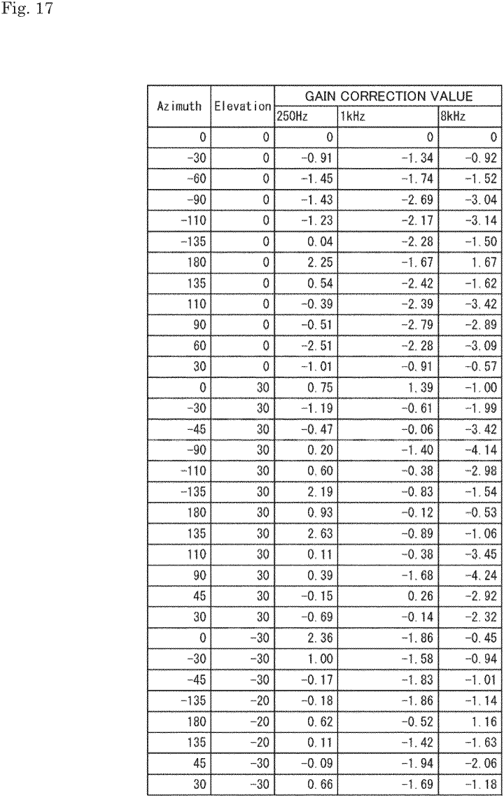

Here, FIG. 17 illustrates an example of an auditory characteristic table in a case where there are gain correction values at three frequencies for one position.

In the example illustrated in FIG. 17, gain correction values at three frequencies of 250 Hz, 1 kHz, and 8 kHz are associated with a position determined by the horizontal angle (Azimuth), the vertical angle (Elevation), and the distance (Radius). Note that the distance (Radius) is assumed to be a fixed value, and the value is not recorded in the auditory characteristic table.

For example, at a position where a horizontal angle is -30 degrees and a vertical angle is 0 degrees, a gain correction value at 250 Hz is -0.91, a gain correction value at 1 kHz is -1.34, and a gain correction value at 8 kHz is -0.92.

Note that an auditory characteristic table in which gain correction values at three frequencies of 250 Hz, 1 kHz, and 8 kHz are prepared for each position is shown as an example here. However, the present technology (is not limited thereto, and the number of frequencies at which gain correction values are prepared for each position and frequencies for which gain correction values are prepared can be set to be any number and frequencies in the auditory characteristic table.

In addition, similarly to the above-described example, a gain correction value at a desired frequency for a position of an object may not be stored in the auditory characteristic table.

Consequently, the gain correction unit 191 may perform interpolation processing or the like on the basis of gain correction values associated with other plurality of frequencies near the desired frequency at the position of the object or a position in the vicinity of the position in the auditory characteristic table to obtain a gain correction value at the desired frequency at the position of the object.

For example, in a case where a gain correction value at a desired frequency is obtained by interpolation processing, any interpolation processing, for example, linear interpolation such as zero-order interpolation or first-order interpolation, non-linear interpolation such as spline interpolation, or interpolation processing in which any linear interpolation and non-linear interpolation are combined may be performed.

Further, in a case where a gain correction value at a minimum or maximum frequency for a desired position does not exist (is not prepared), the gain correction value may be determined on the basis of gain correction values at the surrounding frequencies, or may be set to a fixed value such as 0 dB.

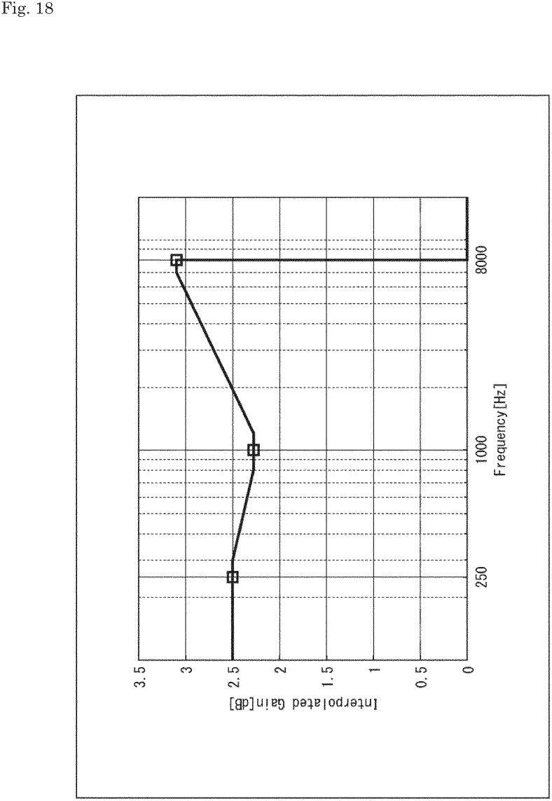

Here, FIG. 18 illustrates an example in which gain correction values at other frequencies are obtained by interpolation processing in a case where there are gain correction values at frequencies of 250 Hz, 1 kHz, and 8 kHz for a predetermined position in the auditory characteristic table, and there are no gain correction values at other frequencies. Note that, in FIG. 18, the vertical axis indicates a gain correction value, and the horizontal axis indicates a frequency.

In this example, interpolation processing such as linear interpolation or non-linear interpolation is performed on the basis of gain correction values at frequencies of 250 Hz, 1 kHz, and 8 kHz to obtain gain correction values at all frequencies.

Incidentally, it is known that an equal loudness curve changes depending on a reproduction sound pressure, and it may be better to switch the auditory characteristic table according to a reproduction sound pressure of an audio signal.

Consequently, for example, the auditory characteristic table holding unit 192 holds an auditory characteristic table for each of a plurality of reproduction sound pressures, and the gain correction unit 191 may select an appropriate one from among the auditory characteristic tables on the basis of the sound pressure of an audio signal of an object. That is, the gain correction unit 191 may switch the auditory characteristic table to be used for the correction of a gain value in accordance with a reproduction sound pressure.

Even in this case, similarly to the above-described interpolation of gain correction values for each position and frequency, when there is no auditory characteristic table of a corresponding sound pressure in the auditory characteristic table holding unit 192, gain correction values of the auditory characteristic table may be obtained by interpolation processing or the like.

In such a case, for example, the gain correction unit 191 performs the interpolation processing or the like on the basis of gain correction values for a predetermined position in the auditory characteristic table associated with a plurality of other reproduction sound pressures close to the sound pressure of the audio signal of the object, that is, near the sound pressure to obtain gain correction values for a predetermined position at the sound pressure of the audio signal of the object. At this time, for example, interpolation may be performed by adding weights according to intervals between curves in an equal loudness curve.

Further, when gain correction of an audio signal (MDCT coefficient) of an object is performed uniformly according to the position, frequency, and reproduction sound pressure, the overall sound quality may rather deteriorate.

Specifically, for example, a case where a minute noise sound that is originally unimportant for auditory sensation is used as the audio signal of the object is conceivable.

In this case, when an object of a minute noise sound is disposed at a position with a large gain correction value, the number of bits allocated to the audio signal of the object is increased in the bit allocation unit 42. Then, the number of bits allocated to sounds (audio signals) of other important objects is reduced accordingly, which leads to a possibility that the sound quality will be degraded.

Thus, a gain correction method may be changed according to the characteristics of the audio signal of the object.

For example, in the above-described example, in a case where it can be determined that perceptual entropy (PE) or sound pressure of an audio signal is equal to or less than a threshold value, that is, the object is not an unimportant object, the gain correction unit 191 may not perform gain correction or may limit the amount of gain correction, that is, may limit a corrected gain value so that the corrected gain value is equal to or less than an upper limit value. Thereby, the correction of the MDCT coefficient (audio signal) using the corrected gain value in the MDCT coefficient correction unit 131 is restricted.

In addition, for example, in a case where the frequency power of an object sound is uneven, the gain correction unit 191 may weight gain correction in a main frequency band and the other frequency bands. In such a case, for example, a gain correction value is corrected according to the frequency power for each frequency band.

Further, it is known that an auditory characteristic table has variations in the characteristics depending on a person. Thus, it is also possible to configure an encoder optimized for a specific user by using an auditory characteristic table optimized for a specific user.

In such a case, for example, the auditory characteristic table holding unit 192 may hold an auditory characteristic table for every plurality of users, the auditory characteristic table being optimized for each user.

Note that the optimization of the auditory characteristic table may be performed using results of an experiment performed to examine auditory characteristics of only a specific person, or may be performed by another method.

### Configuration Example of Encoding Device

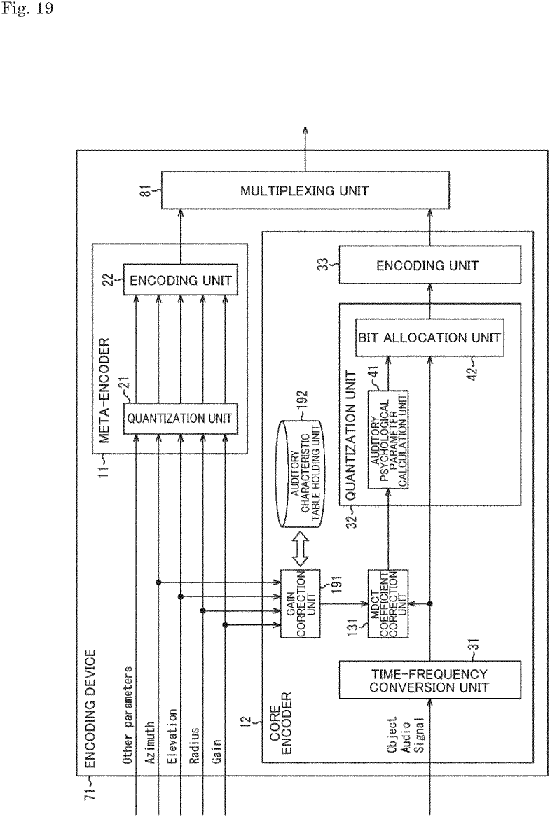

In a case where a gain value is corrected in accordance with auditory characteristics as described above, the encoding device 71 is configured as illustrated in FIG. 19, for example. Note that, in FIG. 19, portions corresponding to those in FIGS. 6 or 14 are denoted by the same reference numerals and signs, and description thereof will be appropriately omitted.

The encoding device 71 illustrated in FIG. 19 includes a meta-encoder 11, a core encoder 12, and a multiplexing unit 81.

Further, the meta-encoder 11 includes a quantization unit 21 and an encoding unit 22, and the core encoder 12 includes a gain correction unit 191, an auditory characteristic table holding unit 192, a time-frequency conversion unit 31, an MDCT coefficient correction unit 131, a quantization unit 32 and an encoding unit 33. Further, the quantization unit 32 includes an auditory psychological parameter calculation unit 41 and a bit allocation unit 42.

The configuration of the encoding device 71 illustrated in FIG. 19 differs from the configuration of the encoding device 71 in FIG. 6 in that the gain correction unit 191 and the auditory characteristic table holding unit 192 are newly provided, and is the same as the configuration of the encoding device 71 in FIG. 6 in other respects.

In the example of FIG. 19, the auditory characteristic table holding unit 192 holds, for example, a three-dimensional auditory characteristic table illustrated in FIG. 16.

In addition, a gain value, horizontal angle, vertical angle, and distance of metadata of an object are supplied to the gain correction unit 191.

The gain correction unit 191 reads gain correction values associated with the horizontal angle, the vertical angle, and the distance as positional information of the supplied metadata from the three-dimensional auditory characteristic table held in the auditory characteristic table holding unit 192.

Note that, in a case where there is no gain correction value corresponding to the position of the object indicated by the positional information of the metadata, the gain correction unit 191 appropriately performs interpolation processing or the like to obtain a gain correction value corresponding to the position of the object indicated by the positional information.

The gain correction unit 191 corrects a gain value of the supplied metadata of the object using the gain correction value obtained in this manner and supplies the resulting corrected gain value to the MDCT coefficient correction unit 131.

Thus, the MDCT coefficient correction unit 131 corrects the MDCT coefficient supplied from the time-frequency conversion unit 31 on the basis of the corrected gain value supplied from the gain correction unit 191, and supplies the resulting corrected MDCT coefficient to the auditory psychological parameter calculation unit 41.

Note that, in the example illustrated in FIG. 19, an example in which metadata before quantization is used for gain correction of an MDCT coefficient has been described, but metadata after encoding or quantization may be used.

In such a case, the gain correction unit 191 decodes or inversely quantizes the encoded or quantized metadata to obtain a corrected gain value on the basis of the resulting gain value, horizontal angle, vertical angle, and distance.

In addition, the gain correction unit 191 and the auditory characteristic table holding unit 192 may be provided in the configurations illustrated in FIGS. 4 and 8.

### Description of Encoding Processing

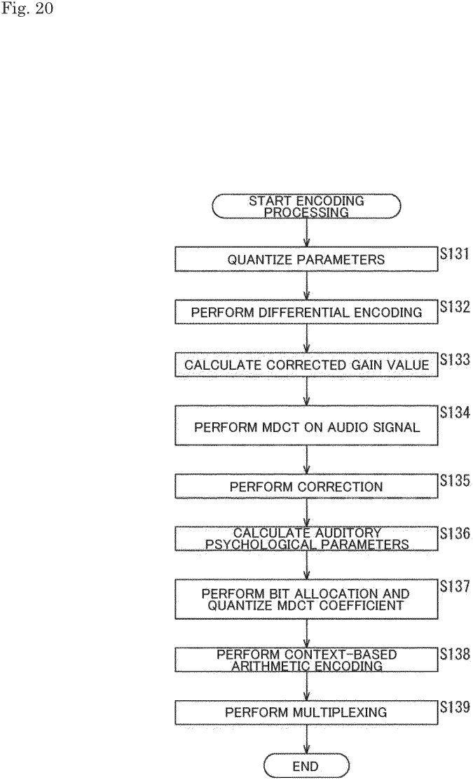

Next, operations of the encoding device 71 illustrated in FIG. 19 will be described. That is, encoding processing performed by the encoding device 71 in FIG. 19 will be described below with reference to a flowchart of FIG. 20.

Note that the processes of steps S131 and S132 are the same as the processes of steps S51 and S52 in FIG. 7, and thus description thereof will be omitted.

In step S133, the gain correction unit 191 calculates a corrected gain value on the basis of the gain value, horizontal angle, vertical angle, and distance of the supplied metadata and supplies the corrected gain value to the MDCT coefficient correction unit 131.

That is, the gain correction unit 191 reads a gain correction value associated with the horizontal angle, the vertical angle, and the distance of the metadata from the three-dimensional auditory characteristic table held in the auditory characteristic table holding unit 192 and corrects the gain value using the gain correction value to calculate a corrected gain value. At this time, interpolation processing or the like is performed appropriately, and thus a gain correction value corresponding to the position of the object indicated by the horizontal angle, vertical angle, and distance is obtained.

When the corrected gain value is obtained in this manner, the processes of steps S134 to S139 are performed thereafter, and the encoding processing is terminated. However, these processes are the same as the processes of steps S53 to S58 in FIG. 7, and thus description thereof will be omitted.

However, in step S135, the MDCT coefficient obtained by the time-frequency conversion unit 31 is corrected on the basis of the corrected gain value obtained by the gain correction unit 191 to obtain a corrected MDCT coefficient.

Note that an auditory characteristic table for each user which is optimized as described above may be held in the auditory characteristic table holding unit 192.

Further, in the auditory characteristic table, a gain correction value may be associated with each of a plurality of frequencies with respect to each position, and the gain correction unit 191 may obtain a gain correction value for a desired frequency by interpolation processing based on the gain correction values for a plurality of other frequencies near the frequency.

For example, in the auditory characteristic table, in a case where a gain correction value for each frequency is associated with each position and stored, the gain correction unit 191 obtains a corrected gain value for each frequency, and the MDCT coefficient correction unit 131 corrects an MDCT coefficient using the corrected gain value for each frequency. In addition, an auditory characteristic table for each reproduction sound pressure may be held in the auditory characteristic table holding unit 192.

As described above, the encoding device 71 corrects a gain value of metadata using a three-dimensional auditory characteristic table, and calculates auditory psychological parameters on the basis of a corrected MDCT coefficient obtained using the resulting corrected gain value.

In this manner, it is possible to obtain auditory psychological parameters that are adapted to the actual auditory sensation even with a small amount of computation and to improve encoding efficiency. In particular, a gain value is corrected on the basis of three-dimensional auditory characteristics, and thus it is possible to obtain auditory psychological parameters that are more adapted to the actual auditory sensation.

### Fifth Embodiment

### Configuration Example of Encoding Device

Incidentally, three-dimensional auditory characteristics include not only a difference in sound pressure sensitivity depending on the direction of arrival of a sound from a sound source, but also auditory masking in a sound between objects, and it is known that the amount of masking between objects varies depending on a distance between the objects and sound frequency characteristics.

However, in general calculation of auditory psychological parameters, auditory masking is calculated individually for each object, and auditory masking between objects is not considered.

For this reason, in a case where sounds of a plurality of objects are reproduced at the same time, quantized bits may be actually used excessively by auditory masking between objects regardless of quantized noise being not perceptible originally.

Consequently, bit allocation with higher encoding efficiency may be performed by calculating auditory psychological parameters using a three-dimensional auditory psychological model taking auditory masking between a plurality of objects into consideration according to the positions and distances of the objects.

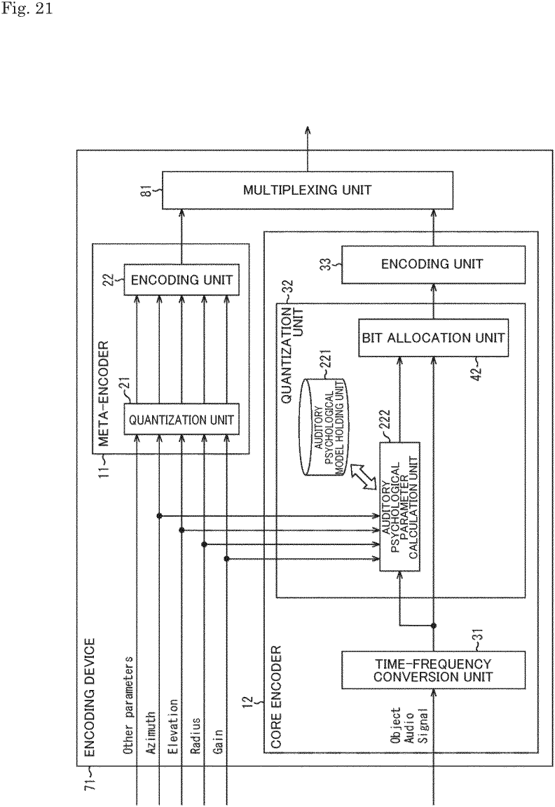

In such a case, the encoding device 71 is configured as illustrated in FIG. 21, for example. In FIG. 21, portions corresponding to those in FIG. 4 are denoted by the same reference numerals and signs, and description thereof will be appropriately omitted.

The encoding device 71 illustrated in FIG. 21 includes a meta-encoder 11, a core encoder 12, and a multiplexing unit 81.

In addition, the meta-encoder 11 includes a quantization unit 21 and an encoding unit 22, and the core encoder 12 includes a time-frequency conversion unit 31, a quantization unit 32, and an encoding unit 33. Further, the quantization unit 32 includes an auditory psychological model holding unit 221, an auditory psychological parameter calculation unit 222, and a bit allocation unit 42.

The configuration of the encoding device 71 illustrated in FIG. 21 differs from the configuration of the encoding device 71 in FIG. 4 in that the auditory psychological model holding unit 221 and the auditory psychological parameter calculation unit 222 are provided instead of the audio signal correction unit 91, the time-frequency conversion unit 92, and the auditory psychological parameter calculation unit 41, and is the same as the configuration of the encoding device 71 in FIG. 4 in other respects.

In this example, the auditory psychological model holding unit 221 holds a three-dimensional auditory psychological model prepared in advance and regarding auditory masking between a plurality of objects. This three-dimensional auditory psychological model is an auditory psychological model taking not only auditory masking of a single object but also auditory masking between a plurality of objects into consideration.

In addition, an MDCT coefficient obtained by the time-frequency conversion unit 31 and a horizontal angle, vertical angle, distance, and gain value of metadata of an object are supplied to the auditory psychological parameter calculation unit 222.

The auditory psychological parameter calculation unit 222 calculates auditory psychological parameters based on three-dimensional auditory characteristics. That is, the auditory psychological parameter calculation unit 222 calculates the auditory psychological parameters on the basis of the MDCT coefficient received from the time-frequency conversion unit 31, the horizontal angle, vertical angle, distance, and gain value of the supplied metadata, and the three-dimensional auditory psychological model held in the auditory psychological model holding unit 221, and supplies the calculated auditory psychological parameters to the bit allocation unit 42.

In the auditory psychological parameter calculation based on such three-dimensional auditory characteristics, it is possible to obtain auditory psychological parameters taking not only auditory masking for each object, which has been hitherto considered, but also auditory masking between objects into consideration.

Thereby, it is possible to perform bit allocation using auditory psychological parameters based on three-dimensional auditory characteristics and to improve encoding efficiency.

### Description of Encoding Processing

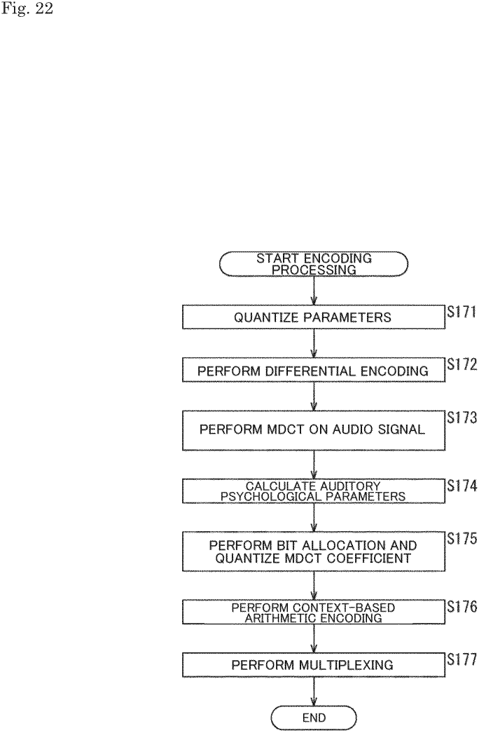

Next, operations of the encoding device 71 illustrated in FIG. 21 will be described. That is, encoding processing performed by the encoding device 71 in FIG. 21 will be described below with reference to a flowchart of FIG. 22.

Note that the processes of steps S171 and S172 are the same as the processes of steps S11 and S12 in FIG. 5, and thus description thereof will be omitted.

In step S173, the time-frequency conversion unit 31 performs MDCT (time-frequency conversion) on the supplied audio signal of the object, and supplies the resulting MDCT coefficient to the auditory psychological parameter calculation unit 222 and the bit allocation unit 42.

In step S174, the auditory psychological parameter calculation unit 222 calculates auditory psychological parameters on the basis of the MDCT coefficient received from the time-frequency conversion unit 31, the horizontal angle, vertical angle, distance, and gain value of the supplied metadata, and the three-dimensional auditory psychological model held in the auditory psychological model holding unit 221, and supplies the calculated auditory psychological parameters to the bit allocation unit 42.

At this time, the auditory psychological parameter calculation unit 222 calculates auditory psychological parameters using not only the MDCT coefficient, horizontal angle, vertical angle, distance, and gain value of the object to be processed, but also MDCT coefficients, horizontal angles, vertical angles, distances, and gain values of other objects.

As a specific example, for example, a case where a masking threshold value as an auditory psychological parameter is obtained will be described.

In this case, the masking threshold value is obtained on the basis of an MDCT coefficient, a gain value, and the like of an object to be processed. In addition, an offset value (correction value) corresponding to a distance and a relative positional relationship between objects, a difference in frequency power (MDCT coefficient), and the like is obtained on the basis of MDCT coefficients, gain values, and positional information of an object to be processed and other objects, and a three-dimensional auditory psychological model. Further, the obtained masking threshold value is corrected using the offset value and is set to be a final masking threshold value.

In this manner, it is possible to obtain auditory psychological parameters also auditory masking between objects into consideration.

When the auditory psychological parameters are calculated, the processes of steps S175 to S177 are performed thereafter, and the encoding processing is terminated. However, these processes are the same as the processes of steps S17 to S19 in FIG. 5, and thus description thereof will be omitted.

As described above, the encoding device 71 calculates auditory psychological parameters on the basis of a three-dimensional auditory psychological model. In this manner, it is possible to perform bit allocation using auditory psychological parameters based on three-dimensional auditory characteristics also taking auditory masking between objects into consideration, and to improve encoding efficiency.

### Sixth Embodiment

### Configuration Example of Encoding Device

Note that the above-described method of using a gain value and positional information of metadata of an object for bit allocation is effective for, for example, a service in which a user performs rendering by using metadata of an object, that is, positions and gains as they are without modification at the time of viewing a distributed content.

On the other hand, such a method cannot be used as it is because there is a possibility that metadata will differ between the case of encoding and the case of rendering in a service in which a user can edit metadata at the time of rendering.

However, even with such a service, content creators do not necessarily permit editing of metadata of all objects, and it is conceivable that content creators designate objects for which users are permitted to edit metadata and objects for which they are not permitted.

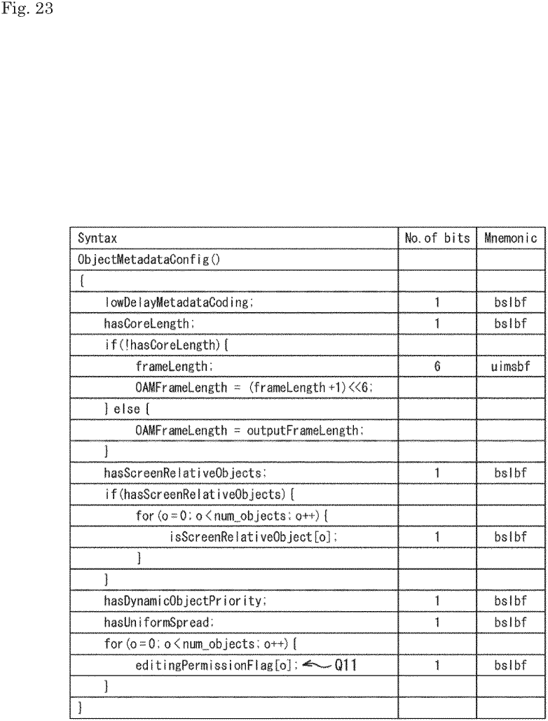

Here, FIG. 23 illustrates the syntax of Config of metadata to which an editing permission flag “editingPermissionFlag” of metadata for each object is added by a content creator. The editing permission flag is an example of editing permission information indicating whether or not editing of metadata is permitted.

In this example, a portion indicated by an arrow Q11 in Config (ObjectMetadataConfig) of the metadata includes an editing permission flag “editingPermissionFlag”.

Here, “num_objects” indicates the number of objects that constitute a content, and in this example, an editing permission flag is stored for each object.

In particular, a value “1” of an editing permission flag indicates that editing of metadata of an object is permitted, and a value “0” of an editing permission flag indicates that editing of metadata of an object is not permitted. The content creator designates (sets) the value of an editing permission flag for each object.

When such an editing permission flag is included in the metadata, it is possible to calculate auditory psychological parameters on the basis of a three-dimensional auditory psychological model for an object for which metadata is not permitted to be edited.

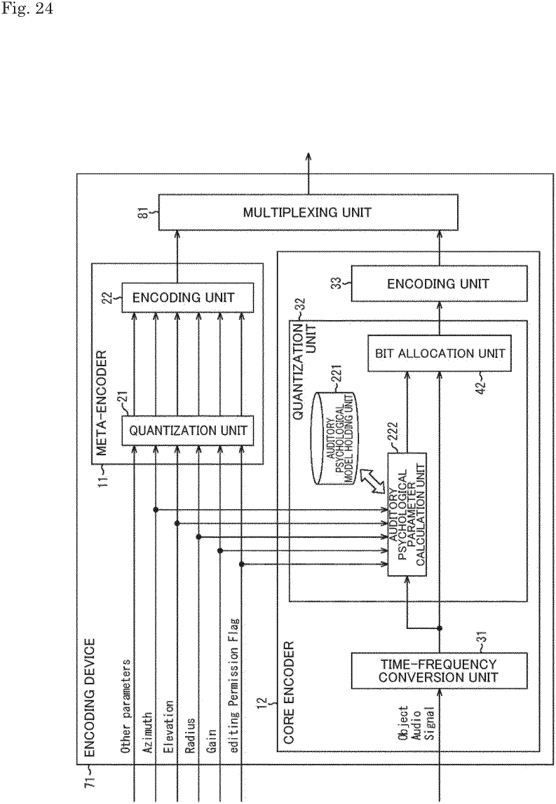

In such a case, the encoding device 71 is configured as illustrated in FIG. 24, for example. Note that, in FIG. 24, portions corresponding to those in FIG. 21 are denoted by the same reference numerals and signs, and description thereof will be appropriately omitted.

The encoding device 71 illustrated in FIG. 24 includes a meta-encoder 11, a core encoder 12, and a multiplexing unit 81.

In addition, the meta-encoder 11 includes a quantization unit 21 and an encoding unit 22, and the core encoder 12 includes a time-frequency conversion unit 31, a quantization unit 32, and an encoding unit 33. Further, the quantization unit 32 includes an auditory psychological model holding unit 221, an auditory psychological parameter calculation unit 222, and a bit allocation unit 42.

The encoding device 71 illustrated in FIG. 24 is basically the same as the encoding device 71 illustrated in FIG. 21, but the encoding device 71 illustrated in FIG. 24 is different from the encoding device 71 in FIG. 21 in that an editing permission flag for each object is included in metadata to be input.

In this example, a horizontal angle, a vertical angle, a distance, a gain value, an editing permission flag, and other parameters are input to the quantization unit 21 as metadata parameters. In addition, the horizontal angle, the vertical angle, the distance, the gain value, and the editing permission flag among the metadata are supplied to the auditory psychological parameter calculation unit 222.

Thus, the auditory psychological parameter calculation unit 222 calculates auditory psychological parameters in the same manner as the auditory psychological parameter calculation unit 41 described with reference to FIG. 4 in accordance with the supplied editing permission flag, or calculates auditory psychological parameters in the same manner as in the example of FIG. 21.

### Description of Encoding Processing

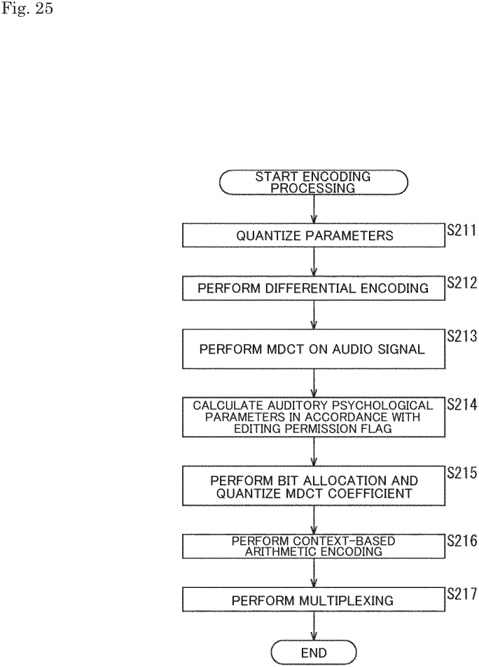

Next, operations of the encoding device 71 illustrated in FIG. 24 will be described. That is, encoding processing performed by the encoding device 71 in FIG. 24 will be described below with reference to a flowchart of FIG. 25.

Note that the processes of steps S211 to S213 are the same as the processes of steps S171 to S173 in FIG. 22, and thus description thereof will be omitted.

In step S214, the auditory psychological parameter calculation unit 222 calculates auditory psychological parameters in accordance with the editing permission flag included in the supplied metadata of the object, and supplies the calculated auditory psychological parameters to the bit allocation unit 42.

For example, in a case where an editing permission flag of an object to be processed is “1” and editing is permitted, the auditory psychological parameter calculation unit 222 calculates auditory psychological parameters on the basis of an MDCT coefficient of the object to be processed, the MDCT coefficient being supplied from the time-frequency conversion unit 31.

In this manner, for an object for which editing is permitted, there is a possibility that metadata will be edited on a decoding (reproduction) side, and thus auditory psychological parameters are calculated without considering auditory masking between objects.

On the other hand, for example, in a case where an editing permission flag of an object to be processed is “0” and editing is not permitted, the auditory psychological parameter calculation unit 222 calculates auditory psychological parameters on the basis of the MDCT coefficients received from the time-frequency conversion unit 31, the horizontal angle, vertical angle, distance, and gain value of the supplied metadata, and the three-dimensional auditory psychological model held in the auditory psychological model holding unit 221.

In this case, the auditory psychological parameter calculation unit 222 calculates auditory psychological parameters in the same manner as in the case of step S174 in FIG. 22. That is, the auditory psychological parameters are calculated using not only the MDCT coefficient, horizontal angle, vertical angle, distance, and gain value of the object to be processed, but also MDCT coefficients, horizontal angles, vertical angles, distances, and gain values of other objects.

In this manner, for an object for which editing is not permitted, auditory psychological parameters are calculated in consideration of auditory masking between objects because metadata is not changed on the decoding (reproduction) side.

When the auditory psychological parameters are calculated, the processes of steps S215 to S217 are performed thereafter, and the encoding processing is terminated. However, these processes are the same as the processes of steps S175 to S177 in FIG. 22, and thus description thereof will be omitted.

As described above, the encoding device 71 calculates auditory psychological parameters appropriately using a three-dimensional auditory psychological model in accordance with an editing permission flag. In this manner, for an object for which editing is not permitted, it is possible to perform bit allocation using auditory psychological parameters based on three-dimensional auditory characteristics also taking auditory masking between objects into consideration. Thereby, it is possible to improve encoding efficiency.

Note that, with respect to the configuration of the encoding device 71 illustrated in FIG. 21, an example in which an editing permission flag is used in combination has been described. However, the present invention is not limited thereto, and for example, an editing permission flag may be used in combination, with respect to the configuration of the encoding device 71 illustrated in FIG. 19.

In such a case, for an object for which editing is not permitted, it is only required that a three-dimensional auditory characteristic table is used to correct a gain value of metadata of the object.

On the other hand, for an object for which editing is permitted, the MDCT coefficient correction unit 131 does not correct an MDCT coefficient, and the auditory psychological parameter calculation unit 41 calculates auditory psychological parameters using the MDCT coefficient obtained by the time-frequency conversion unit 31 as it is.

Further, although an example in which editing permissions for all parameters constituting metadata are managed collectively by one editing permission flag “editingPermissionFlag” has been described here, an editing permission flag may be prepared for each parameter of metadata. In this manner, it is possible to selectively permit editing of some or all of the plurality of parameters included in the metadata by the editing permission flag.

In such a case, for example, only parameters of the metadata for which editing is not permitted by the editing permission flag may be used for the calculation of the auditory psychological parameters.

For example, in the example of FIG. 24, in a case where editing of positional information including a horizontal angle and the like is permitted, but editing of a gain value is not permitted, the gain value is used without using the positional information, and auditory psychological parameters are calculated on the basis of a three-dimensional auditory psychological model.

### Seventh Embodiment

### Configuration Example of Encoding Device

Incidentally, channel-based audio encoding such as 2ch, 5.1ch, and 7.1ch is based on the assumption that sounds obtained by mixing audio signals of various musical instruments are input.

For this reason, it is also necessary to adjust a bit allocation algorithm so that stable operations are generally achieved for signals from the various musical instruments.

On the other hand, in object-based 3D audio encoding, audio signals of individual musical instruments such as a “Vocal”, a “Guitar”, and a “Bass” serving as objects are input. For this reason, it is possible to improve encoding efficiency and increase the speed of arithmetic processing by optimizing algorithms such as bit allocation and parameters (hereinafter also referred to as adjustment parameters) for signals of the musical instruments.

Consequently, for example, the types of sound sources of objects, that is, label information indicating musical instruments such as a “Vocal” and a “Guitar” may be input, and auditory psychological parameters may be calculated using an algorithm or adjustment parameters corresponding to the label information. In other words, bit allocation corresponding to label information may be performed.

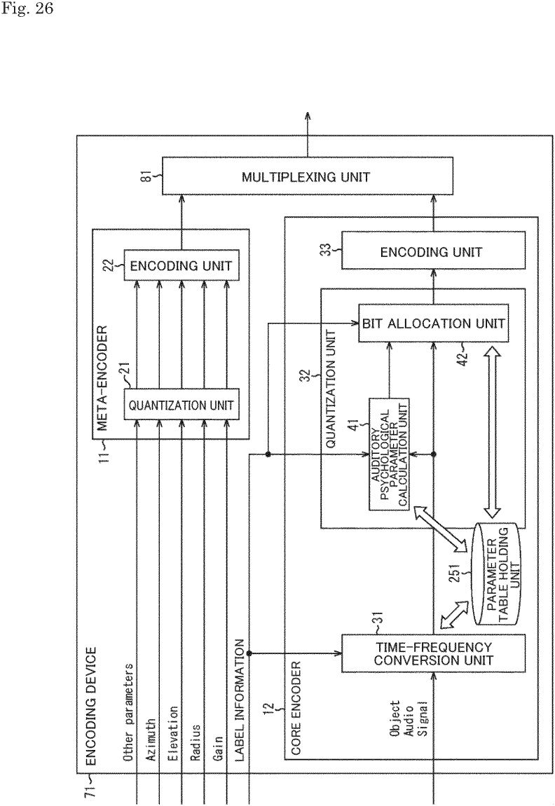

In such a case, the encoding device 71 is configured as illustrated in FIG. 26, for example. Note that, in FIG. 26, portions corresponding to those in FIG. 6 are denoted by the same reference numerals and signs, and description thereof will be appropriately omitted.

The encoding device 71 illustrated in FIG. 26 includes a meta-encoder 11, a core encoder 12, and a multiplexing unit 81.

Further, the meta-encoder 11 includes a quantization unit 21 and an encoding unit 22, and the core encoder 12 includes a parameter table holding unit 251, a time-frequency conversion unit 31, a quantization unit 32, and an encoding unit 33. Further, the quantization unit 32 includes an auditory psychological parameter calculation unit 41 and a bit allocation unit 42.

The configuration of the encoding device 71 illustrated in FIG. 26 differs from the configuration of the encoding device 71 in FIG. 6 in that a parameter table holding unit 251 is provided instead of the MDCT coefficient correction unit 131, and is the same as the configuration of the encoding device 71 in FIG. 6 in other respects.

In this example, label information indicating the types of sound sources of objects, that is, the types of musical instruments of sounds based on audio signals of objects such as a Vocal, a Chorus, a Guitar, a Bass, Drums, a Kick, a Snare, a Hi-hat, a Piano, a Synth, and a String is input (supplied) to the encoding device 71.

For example, the label information can be used for editing or the like of contents constituted by object signals of objects, and the label information may be a character string or the like indicating the type of musical instrument or may be ID information or the like indicating the type of musical instrument.

The parameter table holding unit 251 holds a parameter table in which information indicating algorithms and adjustment parameters used for MDCT calculation, calculation of auditory psychological parameters, and bit allocation is associated with each type of musical instrument (the type of sound source) indicated by the label information. Note that, in the parameter table, at least one of information indicating algorithms and adjustment parameters may be associated with the type of musical instrument (the type of sound source).

The time-frequency conversion unit 31 performs MDCT on a supplied audio signal using adjustment parameters and algorithms determined for the type of musical instrument indicated by supplied label information with reference to the parameter table held in the parameter table holding unit 251.

The time-frequency conversion unit 31 supplies an MDCT coefficient obtained by the MDCT to the auditory psychological parameter calculation unit 41 and the bit allocation unit 42.

In addition, the quantization unit 32 quantizes the MDCT coefficient on the basis of the adjustment parameters and algorithms determined for the type of musical instrument indicated by the label information on the basis of the supplied label information and MDCT coefficient.

That is, the auditory psychological parameter calculation unit 41 calculates auditory psychological parameters on the basis of the MDCT coefficient received from the time-frequency conversion unit 31 using the adjustment parameters and algorithms determined for the type of musical instrument indicated by the supplied label information with reference to the parameter table held in the parameter table holding unit 251, and supplies the calculated auditory psychological parameters to the bit allocation unit 42.

The bit allocation unit 42 performs bit allocation and quantization of the MDCT coefficient on the basis of the MDCT coefficient received from the time-frequency conversion unit 31, the auditory psychological parameters received from the auditory psychological parameter calculation unit 41, and the supplied label information with reference to the parameter table held in the parameter table holding unit 251.

At this time, the bit allocation unit 42 performs bit allocation using the MDCT coefficient, auditory psychological parameters, and the adjustment parameters and algorithms determined for the type of musical instrument indicated by the label information.

Note that there are various methods of optimizing algorithms and adjustment parameters for each type of musical instrument (type of sound source) indicated by label information, and specific examples will be described below.

For example, in MDCT (time-frequency conversion), it is possible to switch windows used for MDCT (transform windows), that is, window functions.

Consequently, for example, a window with a high time resolution such as the Kaiser window may be used for musical instrument objects such as the types of musical instrument of a Hi-hat and a Guitar in which a rise and fall of sounds are important, and a sine window may be used for musical instrument objects such as a Vocal and a Bass in which voluminousness is important.

In this manner, when the type of musical instrument indicated by the label information and information indicating a window function determined for the type of musical instrument are stored in the parameter table in association with each other, MDCT using a window corresponding to the label information can be performed.

Further, also in the calculation of auditory psychological parameters and bit allocation, for example, band limitation according to label information can be performed.

That is, musical instruments in a low register such as a Bass and a Kick, musical instruments in a middle register such as a Vocal, musical instruments in a high register such as a Hi-hat, and musical instruments in a full register such as a Piano differ in important and unnecessary bands in auditory sensation. Consequently, it is possible to reduce quantized bits from each of unnecessary bands by using the label information and allocate many quantized bits to an important band.

Specifically, an object signal of a musical instrument in a low register, such as a Bass or a Kick, originally includes almost no high-range components. However, when an object signal of such a musical instrument includes a lot of high-range noise, many quantized bits are also allocated to a high-range scale factor band in bit allocation.

Consequently, for the type of musical instrument in a low register such as a Bass or a Kick, adjustment parameters and algorithms for the calculation of auditory psychological parameters and bit allocation are determined so that many quantized bits are allocated due to a low range, and fewer quantized bits are allocated to a high range.

In this manner, it is possible to reduce noise by reducing the number of high-range quantized bits not including target signal components, increase the number of low-range quantized bits including target signal components, and improve sound quality and encoding efficiency.

On the other hand, also in auditory psychological parameters such as a masking threshold value, many quantized bits can be allocated to sounds that are easily perceived by auditory sensation for each musical instrument by changing adjustment (adjustment parameters) in accordance with the type of musical instrument such as a musical instrument having strong tonality, a musical instrument having a high noise property, a musical instrument having a large time-variation of a signal, and a musical instrument having little time-variation of a signal.

Further, for example, in encoders such as advanced audio coding (AAC) and USAC, frequency spectrum information (MDCT coefficient) is quantized for each scale factor band.

The quantized value of each scale factor band, that is, the number of bits to be allocated for each scale factor band, starts with a predetermined value as an initial value, and a final value is determined by performing a bit allocation loop.

For example, in the bit allocation loop, quantization of an MDCT coefficient is repeatedly performed while changing the quantized value of each scale factor band, that is, while performing bit allocation, until predetermined conditions are satisfied. The predetermined conditions mentioned here are, for example, a condition that the sum of the number of bits of the quantized MDCT coefficient of each scale factor band is equal to or less than a predetermined allowable number of bits, and a condition that the quantized noise is sufficiently small.

In many cases, it is desirable to shorten the time required for encoding (quantization) such as using a real-time encoder, and such cases are accompanied by a slight degradation of sound quality. However, an upper limit is also set for the number of bit allocation loops (the number of loops) described above.

Naturally, the closer the initial value of the quantized value of each scale factor band to the final value, the fewer the number of bit allocation loops and the shorter an encoding time. In addition, the deterioration of sound quality due to the limitation on the number of loops is also reduced.

Thus, it is possible to encode (quantize) an audio signal with high sound quality in a short period of time by obtaining an optimum initial value in advance for each type of musical instrument indicated by the label information and switching the initial value in accordance with the label information. In this case, for example, the label information may be set as one of auditory psychological parameters, or an initial value of a quantized value as an adjustment parameter may be determined for each type of musical instrument in a parameter table.

The above-described adjustment parameters and algorithms for each type of musical instrument can be obtained in advance by manual adjustment based on experience, statistical adjustment, machine learning, or the like.

In the encoding device 71 having the configuration illustrated in FIG. 26, adjustment parameters and algorithms for each type of musical instrument are prepared in advance as a parameter table. In addition, calculation of auditory psychological parameters, bit allocation, that is, quantization, and MDCT are performed according to adjustment parameters and algorithms corresponding to the label information.

Note that, although the label information is used alone in this example, it may be used in combination with other metadata information.

For example, other parameters of metadata of an object may include priority information indicating the priority of the object.

Consequently, in the time-frequency conversion unit 31, the auditory psychological parameter calculation unit 41, and the bit allocation unit 42, strength and weakness of adjustment parameters determined for the label information may be further performed using the value of the priority indicated by the priority information of the object. In contrast, objects with the same priority may be processed with different priorities using the label information.

In addition, although description has been given by limiting the label information to the type of musical instrument here, it is also possible to use label information for determining a hearing environment other than the type of musical instrument.

For example, in a case where a sound such as a content is heard in a car, quantized noise in a low register is less likely to be perceived due to an engine sound and running noise. In addition, a minimum audible range, that is, a perceptible volume, differs between a quiet room and a crowded outdoors. Further, the hearing environment itself also changes with the elapse of time and the movement of a user.

Consequently, for example, label information including hearing environment information indicating the user’s hearing environment may be input to the encoding device 71, and auditory psychological parameters that are optimal for the user’s hearing environment may be calculated and the like using adjustment parameters and algorithms corresponding to the label information.

In this case, MDCT, the calculation of auditory psychological parameters, and bit allocation are performed using adjustment parameters and algorithms determined for the hearing environment and the type of musical instrument indicated by the label information with reference to, for example, a parameter table.

In this manner, it is possible to perform quantization (encoding) with higher sound quality for various hearing environments. For example, in a car, many bits are allocated to a mid-high range by increasing a masking threshold value of quantized noise in a low register which is less likely to be perceived at the time of quantizing an MDCT coefficient, and thus it is possible to improve sound quality of an object which is the type of musical instrument such as a Vocal.

### Description of Encoding Processing

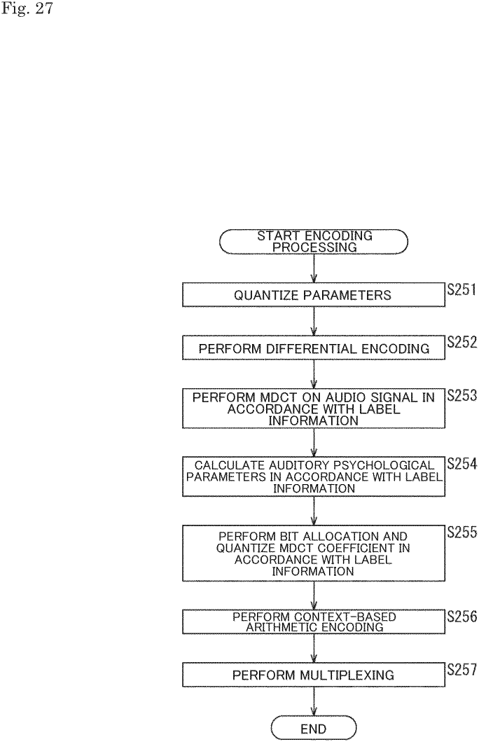

Next, operations of the encoding device 71 illustrated in FIG. 26 will be described. That is, encoding processing performed by the encoding device 71 in FIG. 26 will be described below with reference to a flowchart of FIG. 27.

Note that the processes of steps S251 and S252 are the same as the processes of steps S51 and S52 in FIG. 7, and thus description thereof will be omitted.

In step S253, the time-frequency conversion unit 31 performs MDCT on the supplied audio signal on the basis of the parameter table held in the parameter table holding unit 251 and the supplied label information, and supplies the resulting MDCT coefficient to the auditory psychological parameter calculation unit 41 and the bit allocation unit 42.

For example, in step S253, MDCT is performed on the audio signal of the object using adjustment parameters and algorithms determined for the label information of the object.

In step S254, the auditory psychological parameter calculation unit 41 calculates auditory psychological parameters on the basis of the MDCT coefficient supplied from the time-frequency conversion unit 31 with reference to the parameter table held in the parameter table holding unit 251 according to the supplied label information, and supplies the calculated auditory psychological parameters to the bit allocation unit 42.

For example, in step S254, the auditory psychological parameters for the object are calculated using the adjustment parameters and algorithms determined for the label information of the object.

In step S255, the bit allocation unit 42 performs bit allocation on the basis of the MDCT coefficient supplied from the time-frequency conversion unit 31 and the auditory psychological parameters supplied from the auditory psychological parameter calculation unit 41 with reference to the parameter table held in the parameter table holding unit 251 according to the supplied label information, and quantizes the MDCT coefficient.

When the MDCT coefficient is quantized in this manner, the processes of steps S256 and S257 are performed thereafter, and the encoding processing is terminated. However, these processes are the same as the processes of steps S57 and S58 in FIG. 7, and thus description thereof will be omitted.

As described above, the encoding device 71 performs MDCT, calculation of auditory psychological parameters, and bit allocation in accordance with the label information. In this manner, it is possible to improve encoding efficiency and the processing speed of quantization calculation and realize audio reproduction with higher sound quality.

### Eighth Embodiment

### Configuration Example of Encoding Device

In addition, the encoding device 71 that performs quantization (encoding) using label information is also applicable in a case where positional information of a user and positional information of an object are used in combination, such as MPEG-I free viewpoint.

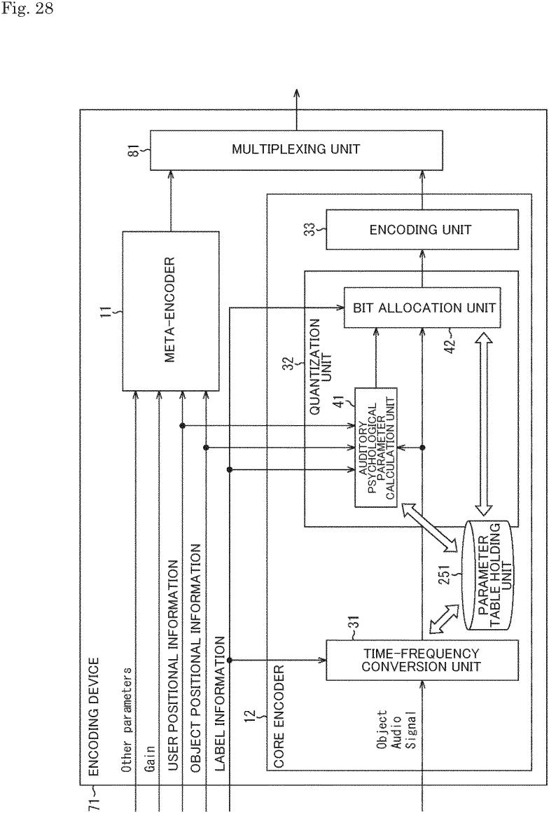

In such a case, the encoding device 71 is configured as illustrated in FIG. 28, for example. In FIG. 28, portions corresponding to those in FIG. 26 are denoted by the same reference numerals and signs, and description thereof will be appropriately omitted.

The encoding device 71 illustrated in FIG. 28 includes a meta-encoder 11, a core encoder 12, and a multiplexing unit 81.

Although not illustrated in the drawing, the meta-encoder 11 includes a quantization unit 21 and an encoding unit 22.

Further, the core encoder 12 includes a parameter table holding unit 251, a time-frequency conversion unit 31, a quantization unit 32, and an encoding unit 33, and the quantization unit 32 includes an auditory psychological parameter calculation unit 41 and a bit allocation unit 42.

The configuration of the encoding device 71 illustrated in FIG. 28 is basically the same as that of the encoding device 71 illustrated in FIG. 26, but differs from the configuration of the encoding device 71 illustrated in FIG. 26 in that the position of a user, that is, user positional information indicating a hearing position of a sound such as a content is further input by the user in the encoding device 71 illustrated in FIG. 28.

The meta-encoder 11 encodes metadata including parameters such as positional information of an object and gain values, but the positional information of the object included in the metadata is different from that in the example illustrated in FIG. 26.

For example, in this example, positional information indicating the relative position of the object seen from the user (hearing position), positional information indicating the absolute position of the object modified appropriately, and the like are encoded as positional information constituting metadata of the object on the basis of the user positional information, and the supplied horizontal angle, vertical angle, and distance of the object.

Note that, for example, the user positional information is supplied from a client device (not illustrated) which is a distribution destination (transmission destination) of a bitstream containing a content generated by the encoding device 71, that is, encoded metadata and encoded audio data.

Further, the auditory psychological parameter calculation unit 41 calculates auditory psychological parameters using not only the label information but also the supplied positional information of the object, that is, the horizontal angle, the vertical angle, and the distance indicating the position of the object, and the user positional information.

In addition, the user positional information and the object positional information may also be supplied to the bit allocation unit 42, and the user positional information and the object positional information may be used for bit allocation.

Here, an example of calculation of auditory psychological parameters which is performed by the auditory psychological parameter calculation unit 41 and bit allocation performed by the bit allocation unit 42 is described. In particular, an example in which a content is a live music content is described here.

In this case, a user listens to the sound of a content in a virtual live hall, but sounds heard in a front row and a last row of the live hall differ greatly.

Consequently, for example, in a case where the user listens to the sound of the content at a position close to an object in the front row in a free viewpoint, quantized bits are preferentially allocated to an object located at a position close to the user instead of being allocated uniformly even when the same label information is assigned to a plurality of objects. In this manner, it is possible to give the user a sense of reality as if the user is closer to the object, that is, a high sense of presence.

In contrast, in a case where the user listens to the sound of the content at a position far from the object in the last row, the original adjustment for each type of musical instrument, that is, adjustment for a longer distance, may be performed on the adjustment parameters and algorithms corresponding to the label information.

For example, even with the sound of a musical instrument where it is better to allocate more bits to an attack sound and a connection sound, many bits are allocated to the decay of a signal, echoes and a reverberation portion, and thus it is possible to improve a sense of space and give the user a sense of presence as if the user is in a large hall.

In this manner, it is possible to further improve a sense of presence by performing calculation of auditory psychological parameters and bit allocation in accordance with not only the label information but also the position of the user in a three-dimensional space, that is, a hearing position indicated by the user positional information, and a distance between the user and the object.

### Description of Encoding Processing

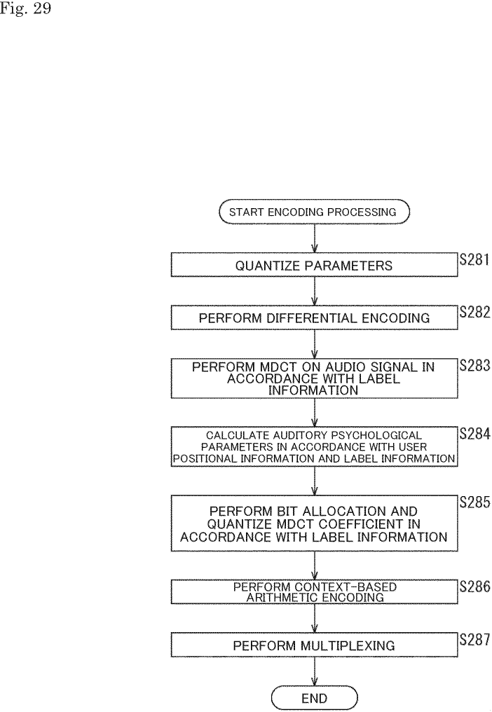

Next, operations of the encoding device 71 illustrated in FIG. 28 will be described. That is, encoding processing performed by the encoding device 71 in FIG. 28 will be described below with reference to a flowchart of FIG. 29.

In step S281, the quantization unit 21 of the meta-encoder 11 quantizes parameters as supplied metadata and supplies the resulting quantized parameters to the encoding unit 22.

Note that, in step S281, the same processing as in step S251 of FIG. 27 is performed, but the quantization unit 21 quantizes positional information indicating the relative position of the object seen from the user, positional information indicating the appropriately modified absolute position of the object, or the like as positional information constituting the metadata of the object, on the basis of the supplied user positional information and object positional information.

When the process of step S281 is performed, the processes of steps S282 to S287 are performed thereafter, and the encoding processing is terminated. However, these processes are the same as the processes of steps S252 to S257 in FIG. 27, and thus description thereof will be omitted.

However, in step S284, the auditory psychological parameters are calculated using not only the label information but also the user positional information and the object positional information, as described above. Further, in step S285, bit allocation may be performed using the user positional information or the object positional information.

As described above, the encoding device 71 performs calculation of auditory psychological parameters and bit allocation using not only the label information but also the user positional information and the object positional information. In this manner, it is possible to improve encoding efficiency and the processing speed of quantization calculation, improve a sense of presence, and realize audio reproduction with higher sound quality.

As described above, the present technology takes a gain value of metadata applied in rendering at the time of viewing, the position of an objects, and the like into consideration, and thus it is possible to perform calculation of auditory psychological parameters and bit allocation adapted to the actual auditory sensation and to improve encoding efficiency.

In addition, even when a gain value of metadata created by a content creator falls outside the range of the MPEG-H specifications, the gain value is not actually limited to upper and lower limit values in the specification range, and it is possible to reproduce a rendering sound as intended by the creator except for sound quality deterioration due to quantization.

For example, there is a case where an audio signal of a certain object has the same level of gain as another object, and a gain value in metadata is 0 (-∞ dB), which is intended for a noise gate. In such a case, even though an audio signal which is actually rendered and viewed is zero data, bits are allocated in the same manner as other objects in a general encoding device. However, in the present technology, bit allocation is performed as zero data, and thus it is possible to significantly reduce the number of quantized bits.

### Configuration Example of Computer

Incidentally, the above-described series of processes can also be executed by hardware or software. In a case where the series of processes is executed by software, a program that configures the software is installed on a computer. Here, the computer includes, for example, a computer built in dedicated hardware, a general-purpose personal computer on which various programs are installed to be able to execute various functions, and the like.

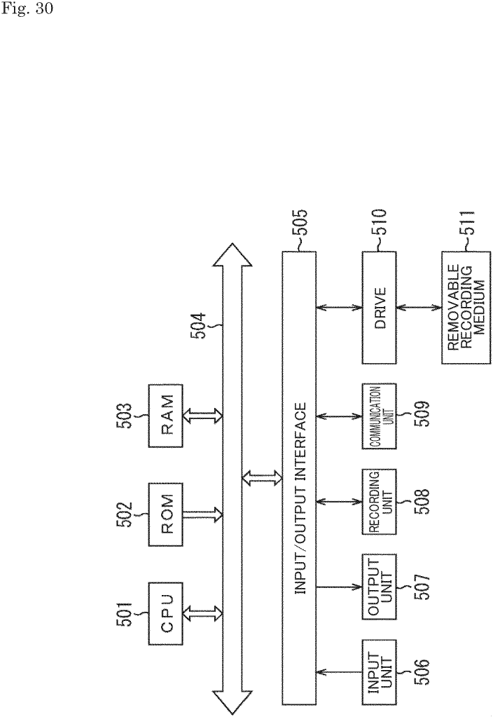

FIG. 30 is a block diagram illustrating a configuration example of computer hardware that executes the above-described series of processes using a program.

In the computer, a central processing unit (CPU) 501, a read only memory (ROM) 502, and a random access memory (RAM) 503 are connected to each other by a bus 504.

An input/output interface 505 is further connected to the bus 504. An input unit 506, an output unit 507, a recording unit 508, a communication unit 509, and a drive 510 are connected to the input/output interface 505.

The input unit 506 is a keyboard, a mouse, a microphone, an imaging element, or the like. The output unit 507 is a display, a speaker, or the like. The recording unit 508 is constituted of a hard disk, a non-volatile memory, or the like. The communication unit 509 is a network interface or the like. The drive 510 drives a removable recording medium 511 such as a magnetic disk, an optical disc, a magneto-optical disk, or a semiconductor memory.

In the computer that has the above configuration, for example, the CPU 501 performs the above-described series of processes by loading a program stored in the recording unit 508 to the RAM 503 via the input/output interface 505 and the bus 504 and executing the program.

The program executed by the computer (the CPU 501) can be recorded on, for example, the removable recording medium 511 serving as a package medium for supply. The program can be supplied via a wired or wireless transmission medium such as a local area network, the Internet, or digital satellite broadcasting.

In the computer, by mounting the removable recording medium 511 on the drive 510, it is possible to install the program in the recording unit 508 via the input/output interface 505. Further, the program can be received by the communication unit 509 via a wired or wireless transmission medium to be installed in the recording unit 508. In addition, this program may be installed in advance in the ROM 502 or the recording unit 508.

Note that the program executed by a computer may be a program that performs processing chronologically in the order described in the present specification or may be a program that performs processing in parallel or at a necessary timing such as a called time.

Embodiments of the present technology are not limited to the above-described embodiments and can be changed variously within the scope of the present technology without departing from the gist of the present technology.

For example, the present technology may be configured as cloud computing in which a plurality of devices share and cooperatively process one function via a network.

In addition, each step described in the above flowchart can be executed by one device or executed in a shared manner by a plurality of devices.

Further, in a case in which one step includes a plurality of processes, the plurality of processes included in the one step can be executed by one device or executed in a shared manner by a plurality of devices.

Further, the present technology can be configured as follows.

(1) A signal processing device including:
a correction unit configured to correct an audio signal of an audio object based on a gain value included in metadata of the audio object; and a quantization unit configured to calculate auditory psychological parameters based on a signal obtained by the correction and to quantize the audio signal.

The signal processing device according to (1), wherein the correction unit corrects the audio signal in a time domain based on the gain value.

The signal processing device according to (2), further including: a time-frequency conversion unit configured to perform time-frequency conversion on the corrected audio signal obtained by the correction by the correction unit, and

wherein the quantization unit calculates the auditory psychological parameters based on frequency spectrum information obtained by the time-frequency conversion.

The signal processing device according to (1), further including:
a time-frequency conversion unit configured to perform time-frequency conversion on the audio signal,
wherein the correction unit corrects frequency spectrum information obtained by the time-frequency conversion based on the gain value, and the quantization unit calculates the auditory psychological parameters based on the corrected frequency spectrum information obtained by correction of the correction unit.

The signal processing device according to any one of (1) to (4), further including:
a gain correction unit configured to correct the gain value based on auditory characteristics related to a direction of arrival of a sound,
wherein the correction unit corrects the audio signal based on the corrected gain value.

The signal processing device according to (5), wherein the gain correction unit corrects the gain value based on the auditory characteristics with respect to a position indicated by positional information included in the metadata.

The signal processing device according to (6), further including:

an auditory characteristic table holding unit configured to hold an auditory characteristic table in which the position of the audio object and a gain correction value for performing correction based on the auditory characteristics of the gain value for the position of the audio object are associated with each other.

The signal processing device according to (7), wherein, in a case where the gain correction value corresponding to the position indicated by the positional information is not in the auditory characteristic table, the gain correction unit performs interpolation processing based on a plurality of the gain correction values in the auditory characteristic table to obtain the gain correction value for a position indicated by the positional information.

The signal processing device according to (8), wherein the gain correction unit performs the interpolation processing based on the gain correction values associated with the plurality of positions near the position indicated by the positional information.

The signal processing device according to (9), wherein the interpolation processing is interpolation processing using VBAP.

The signal processing device according to (8), wherein the gain correction value is associated with each of a plurality of frequencies for each position in the auditory characteristic table, and

in a case where the auditory characteristic table does not include the gain correction value for a predetermined frequency corresponding to the position indicated by the positional information, the gain correction unit performs the interpolation processing based on the gain correction values of a plurality of other frequencies near the predetermined frequency to obtain the gain correction value for the predetermined frequency for the position indicated by the positional information, the plurality of other frequencies corresponding to the position indicated by the positional information.

The signal processing device according to (8), wherein the auditory characteristic table holding unit holds the auditory characteristic table for each reproduction sound pressure, and

the gain correction unit switches the auditory characteristic table used to correct the gain value based on a sound pressure of the audio signal.

The signal processing device according to (12), wherein, in a case where the auditory characteristic table corresponding to the sound pressure of the audio signal is not held in the auditory characteristic table holding unit, the gain correction unit performs the interpolation processing based on the gain correction value corresponding to the position indicated by the positional information in the auditory characteristic table of a plurality of other reproduction sound pressures near the sound pressure to obtain the gain correction value for the position indicated by the positional information corresponding to the sound pressure.

The signal processing device according to any one of (7) to (13), wherein the gain correction unit limits the gain value in accordance with characteristics of the audio signal.

The signal processing device according to (7), wherein, in a case where the gain correction value corresponding to the position indicated by the positional information is not in the auditory characteristic table, the gain correction unit corrects the gain value using the gain correction value associated with a position closest to the position indicated by the positional information.

The signal processing device according to (7), wherein, in a case where the gain correction value corresponding to the position indicated by the positional information is not in the auditory characteristic table, the gain correction unit sets an average value of the gain correction values associated with the plurality of positions near the position indicated by the positional information as the gain correction value of the position indicated by the positional information.

A signal processing method including:

causing a signal processing device to correct an audio signal of an audio object based on a gain value included in metadata of the audio object, and to calculate auditory psychological parameters based on a signal obtained by the correction and to quantize the audio signal.

A program causing a computer to execute processing including steps including:
correcting an audio signal of an audio object based on a gain value included in metadata of the audio object; and
calculating auditory psychological parameters based on a signal obtained by the correction and quantizing the audio signal.

A signal processing device including:
a modification unit configured to modify a gain value of an audio object and an audio signal based on the gain value included in metadata of the audio object; and
a quantization unit configured to quantize the modified audio signal obtained by the modification.

The signal processing device according to (19), wherein the modification unit performs the modification in a case where the gain value is a value falling outside a predetermined range.

The signal processing device according to (19) or (20), further including:
a correction unit configured to correct the modified audio signal based on the modified gain value obtained by the modification,
wherein the quantization unit quantizes the modified audio signal based on a signal obtained by correcting the modified audio signal.

The signal processing device according to any one of (19) to (21), further including:
a meta-encoder configured to quantize and encode the metadata including the modified gain value obtained by the modification;
an encoding unit configured to encode the quantized modified audio signal; and
a multiplexing unit configured to multiplex the encoded metadata and the encoded modified audio signal.

The signal processing device according to any one of (19) to (22), wherein the modification unit modifies the audio signal based on a difference between the gain value and the modified gain value obtained by the modification.

A signal processing method including: causing a signal processing device to modify a gain value of an audio object and an audio signal based on the gain value included in metadata of the audio object, and to quantize the modified audio signal obtained by the modification.

A program causing a computer to execute processing including steps including:
modifying a gain value of an audio object and an audio signal based on the gain value included in metadata of the audio object; and
quantizing the modified audio signal obtained by the modification.

A signal processing device including:

a quantization unit configured to calculate auditory psychological parameters based on metadata including at least one of a gain value and positional information of an audio object, an audio signal of the audio object, and an auditory psychological model related to auditory masking between a plurality of the audio objects, and to quantize the audio signal based on the auditory psychological parameters.

The signal processing device according to (26), further including:
a time-frequency conversion unit configured to perform time-frequency conversion on the audio signal,
wherein the quantization unit calculates the auditory psychological parameters based on frequency spectrum information obtained by the time-frequency conversion.

The signal processing device according to (26) or (27), wherein the quantization unit calculates the auditory psychological parameters based on the metadata and the audio signal of the audio object to be processed, the metadata and the audio signals of the other audio objects, and the auditory psychological model.

The signal processing device according to any one of (26) to (28), wherein the metadata includes editing permission information indicating permission of editing of some or all of a plurality of parameters including the gain value and the positional information included in the metadata, and the quantization unit calculates the auditory psychological parameters based on the parameters for which editing is not permitted by the editing permission information, the audio signals, and the auditory psychological model.

A signal processing method including:

causing a signal processing device to calculate auditory psychological parameters based on metadata including at least one of a gain value and positional information of an audio object, an audio signal of the audio object, and an auditory psychological model related to auditory masking between a plurality of the audio objects, and to quantize the audio signal based on the auditory psychological parameters.

A program causing a computer to execute processing including steps comprising: calculating auditory psychological parameters based on metadata including at least one of a gain value and positional information of an audio object, an audio signal of the audio object, and an auditory psychological model related to auditory masking between a plurality of the audio objects, and quantizing the audio signal based on the auditory psychological parameters.

A signal processing device including:

a quantization unit configured to quantize an audio signal of an audio object using at least one of an adjustment parameter and an algorithm determined for the type of sound source indicated by label information indicating the type of sound source of the audio object, based on the audio signal of the audio object and the label information.

The signal processing device according to (32), wherein the quantization unit calculates auditory psychological parameters based on the audio signal and the label information, and quantizes the audio signal based on the auditory psychological parameters.

The signal processing device according to (32) or (33), wherein the quantization unit performs bit allocation and quantization of the audio signal based on the label information.

The signal processing device according to any one of (32) to (34), further including:
a time-frequency conversion unit configured to perform time-frequency conversion on the audio signal using at least one of the adjustment parameter and the algorithm determined for the type of sound source indicated by the label information, based on the label information,
wherein the quantization unit calculates the auditory psychological parameters based on frequency spectrum information obtained by the time-frequency conversion, and quantizes the frequency spectrum information.

The signal processing device according to any one of (32) to (35), wherein the label information further includes hearing environment information indicating a sound hearing environment based on the audio signal, and the quantization unit quantizes the audio signal using at least one of an adjustment parameter and an algorithm determined for the type of sound source and the hearing environment indicated by the label information.

The signal processing device according to any one of (32) to (35), wherein the quantization unit adjusts an adjustment parameter determined for the type of sound source indicated by the label information, based on the priority of the audio object.

The signal processing device according to any one of (32) to (35), wherein the quantization unit quantizes the audio signal based on positional information of a user, positional information of the audio object, the audio signal, and the label information.

A signal processing method including:

causing a signal processing device to quantize an audio signal of an audio object using at least one of an adjustment parameter and an algorithm determined for the type of sound source indicated by label information indicating the type of sound source of the audio object, based on the audio signal of the audio object and the label information.

A program causing a computer to execute processing including steps including:

quantizing an audio signal of an audio object using at least one of an adjustment parameter and an algorithm determined for the type of sound source indicated by label information indicating the type of sound source of the audio object, based on the audio signal of the audio object and the label information.

### REFERENCE SIGNS LIST

11 Meta-encoder
12 Core encoder
31 Time-frequency conversion unit
32 Quantization unit
33 Encoding unit
71 Encoding device
81 Multiplexing unit
91 Audio signal correction unit
92 Time-frequency conversion unit
131 MDCT coefficient correction unit

1. A signal processing device comprising:
a correction unit configured to correct an audio signal of an audio object based on a gain value included in metadata of the audio object; and
a quantization unit configured to calculate auditory psychological parameters based on a signal obtained by the correction and to quantize the audio signal.

2. The signal processing device according to claim 1, wherein the correction unit corrects the audio signal in a time domain based on the gain value.

3. The signal processing device according to claim 2, further comprising:
a time-frequency conversion unit configured to perform time-frequency conversion on the corrected audio signal obtained by the correction by the correction unit,
wherein the quantization unit calculates the auditory psychological parameters based on frequency spectrum information obtained by the time-frequency conversion.

4. The signal processing device according to claim 1, further comprising:
a time-frequency conversion unit configured to perform time-frequency conversion on the audio signal,
wherein the correction unit corrects frequency spectrum information obtained by the time-frequency conversion based on the gain value, and the quantization unit calculates the auditory psychological parameters based on the corrected frequency spectrum information obtained by correction of the correction unit.

5. The signal processing device according to claim 1, further comprising:
a gain correction unit configured to correct the gain value based on auditory characteristics related to a direction of arrival of a sound,
wherein the correction unit corrects the audio signal based on the corrected gain value.

6. The signal processing device according to claim 5, wherein the gain correction unit corrects the gain value based on the auditory characteristics with respect to a position indicated by positional information included in the metadata.

7. The signal processing device according to claim 6, further comprising:
an auditory characteristic table holding unit configured to hold an auditory characteristic table in which the position of the audio object and a gain correction value for performing correction based on the auditory characteristics of the gain value for the position of the audio object are associated with each other.

8. The signal processing device according to claim 7, wherein, in a case where the gain correction value corresponding to the position indicated by the positional information is not in the auditory characteristic table, the gain correction unit performs interpolation processing based on the gain correction values associated with a plurality of positions near the position indicated by the positional information to obtain the gain correction value of the position indicated by the positional information, to set the gain correction value associated with a position closest to the position indicated by the positional information as the gain correction value of the position indicated by the positional information, or to set an average value of the gain correction values associated with the plurality of positions near the position indicated by the positional information as the gain correction value of the position indicated by the positional information.

9. The signal processing device according to claim 8, wherein the interpolation processing is interpolation processing using VBAP.

10. A signal processing method comprising:
causing a signal processing device to correct an audio signal of an audio object based on a gain value included in metadata of the audio object, and to calculate auditory psychological parameters based on a signal obtained by the correction and to quantize the audio signal.

11. A program causing a computer to execute processing including steps comprising:
correcting an audio signal of an audio object based on a gain value included in metadata of the audio object; and
calculating auditory psychological parameters based on a signal obtained by the correction and quantizing the audio signal.

12. A signal processing device comprising:
a modification unit configured to modify a gain value of an audio object and an audio signal based on the gain value included in metadata of the audio object; and
a quantization unit configured to quantize the modified audio signal obtained by the modification.

13. The signal processing device according to claim 12, wherein the modification unit performs the modification in a case where the gain value is a value falling outside a predetermined range.

14. The signal processing device according to claim 12, further comprising:
a correction unit configured to correct the modified audio signal based on the modified gain value obtained by the modification,
wherein the quantization unit quantizes the modified audio signal based on a signal obtained by correcting the modified audio signal.

15. The signal processing device according to claim 12, further comprising:
a meta-encoder configured to quantize and encode the metadata including the modified gain value obtained by the modification;
an encoding unit configured to encode the quantized modified audio signal; and
a multiplexing unit configured to multiplex the encoded metadata and the encoded modified audio signal.

16. The signal processing device according to claim 12, wherein the modification unit modifies the audio signal based on a difference between the gain value and the modified gain value obtained by the modification.

17. A signal processing method comprising: causing a signal processing device to modify a gain value of an audio object and an audio signal based on the gain value included in metadata of the audio object, and to quantize the modified audio signal obtained by the modification.

18. A program causing a computer to execute processing including steps comprising:
modifying a gain value of an audio object and an audio signal based on the gain value included in metadata of the audio object; and quantizing the modified audio signal obtained by the modification.

19. A signal processing device comprising:
a quantization unit configured to calculate auditory psychological parameters based on metadata including at least one of a gain value and positional information of an audio object, an audio signal of the audio object, and an auditory psychological model related to auditory masking between a plurality of the audio objects, and to quantize the audio signal based on the auditory psychological parameters.

20. The signal processing device according to claim 19, further comprising:
a time-frequency conversion unit configured to perform time-frequency conversion on the audio signal,
wherein the quantization unit calculates the auditory psychological parameters based on frequency spectrum information obtained by the time-frequency conversion.

21. The signal processing device according to claim 19, wherein the quantization unit calculates the auditory psychological parameters based on the metadata and the audio signal of the audio object to be processed, the metadata and the audio signals of the other audio objects, and the auditory psychological model.

22. The signal processing device according to claim 19, wherein the metadata includes editing permission information indicating permission to edit some or all of a plurality of parameters including the gain value and the positional information included in the metadata, and
the quantization unit calculates the auditory psychological parameters based on the parameters for which editing is not permitted by the editing permission information, the audio signals, and the auditory psychological model.

23. A signal processing method comprising:
causing a signal processing device to calculate auditory psychological parameters based on metadata including at least one of a gain value and positional information of an audio object, an audio signal of the audio object, and an auditory psychological model related to auditory masking between a plurality of the audio objects, and to quantize the audio signal based on the auditory psychological parameters.

24. A program causing a computer to execute processing including steps comprising:
calculating auditory psychological parameters based on metadata including at least one of a gain value and positional information of an audio object, an audio signal of the audio object, and an auditory psychological model related to auditory masking between a plurality of the audio objects, and quantizing the audio signal based on the auditory psychological parameters.

25. A signal processing device comprising:
a quantization unit configured to quantize an audio signal of an audio object using at least one of an adjustment parameter and an algorithm determined for the type of sound source indicated by label information indicating the type of sound source of the audio object, based on the audio signal and the label information.

26. The signal processing device according to claim 25, wherein the quantization unit calculates auditory psychological parameters based on the audio signal and the label information, and quantizes the audio signal based on the auditory psychological parameters.

27. The signal processing device according to claim 25, wherein the quantization unit performs bit allocation and quantization of the audio signal based on the label information.

28. The signal processing device according to claim 25, further comprising:
a time-frequency conversion unit configured to perform time-frequency conversion on the audio signal using at least one of the adjustment parameter and the algorithm determined for the type of sound source indicated by the label information, based on the label information, wherein the quantization unit calculates the auditory psychological parameters based on frequency spectrum information obtained by the time-frequency conversion, and quantizes the frequency spectrum information.

29. The signal processing device according to claim 25, wherein the label information further includes hearing environment information indicating a sound hearing environment based on the audio signal, and
the quantization unit quantizes the audio signal using at least one of an adjustment parameter and an algorithm determined for the type of sound source and the hearing environment indicated by the label information.

30. The signal processing device according to claim 25, wherein the quantization unit adjusts an adjustment parameter determined for the type of sound source indicated by the label information, based on the priority of the audio object.

31. The signal processing device according to claim 25, wherein the quantization unit quantizes the audio signal based on positional information of a user, positional information of the audio object, the audio signal, and the label information.

32. A signal processing method comprising:
causing a signal processing device to quantize an audio signal of an audio object using at least one of an adjustment parameter and an algorithm determined for the type of sound source indicated by label information indicating the type of sound source of the audio object, based on the audio signal of the audio object and the label information.

33. A program causing a computer to execute processing including steps comprising:
quantizing an audio signal of an audio object using at least one of an adjustment parameter and an algorithm determined for the type of sound source indicated by label information indicating the type of sound source of the audio object, based on the audio signal of the audio object and the label information.
